(19) United States
(12) Patent Application Publication
(10) Pub. No.: US 2007/0245728 A1
(43) Pub. Date: Oct. 25, 2007

(54) Anti-pollution motors/engines run by air/liquid/gas cycle, spring force, pump, energy blades

(76) Inventor: Henri Duong, Alhambra, CA (US)

Correspondence Address: Henri Duong, 316 1/2 E Glendon way, Alhambra, CA, 91801, US

(21) Appl. No.: 11/409,918

(22) Filed: Apr. 25, 2006

(51) Int. Cl. F03G 3/04

(52) U.S. Cl. 60/639

(57) ABSTRACT

Anti-pollution engines are used for/in all kinds of transportations; all engine-vehicles, motor-vehicles, cars, automobiles, trucks, buses, vans, trains, underground trains, motorcycles, airplanes, helicopters, space rockets, missiles, ships, fleet, submarines, tractors, cultivators, tanks, generators, pumps, compressors, machineries, equipments, appliances, motors/engines of all sorts, and moving objects of all sorts without using energy or least energy of gasoline, fuel, gas and/or nuclear etc for modernizing motors/engines of all sorts.

### CROSS-REFERENCE TO RELATED APPLICATIONS

Disclosure Document Deposit Request; Disclosure Document
No: 503815 date Jan. 18, 2002
No: 549708 date Mar. 25, 2004
No: 565124 date Nov. 15, 2004
No: 587054 date Sep. 29, 2005

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

Gasoline is a vital energy making industrial countries up to date, motor/engine vehicles depend totally gasoline, fuel on running, gasoline is not a recycle energy to be dependable eternally. Solution comes out in my research that gasoline will be replaced by compress air cycle, spring force, air pump, motor fully charged by battery, energy blades partly in gasoline/diesel engine that motor/engine will run neither cost of energy nor heating of current explosion for motor/engine vehicles of all sorts; cars, motorcycles, trains, ships, airplanes, helicopters, submarine, motors/engines of all sorts, all moving objects.

### BRIEF SUMMARY OF THE INVENTION

Advantages of the Invention Are:
using compress air/liquid cycle, air/liquid under pressure pushing pistons in an engine neither cost of gasoline/fuel nor over heating by current explosion.
using springs, shock absorber or any other spring force in place of spark plug and gasoline/fuel combustion in an engine for saving energy.
using (spring) pump rotated by engine/motor spin concluding engine power without using gasoline/fuel.
using either more alternators/dynamos or more powerful alternators charging largely batteries rotating motors to run engines without using energy.
anti-pollution engines to protect atmosphere for human health.

The invention includes original fundamentals, structures, process of making the invention, distributor caps of double connections. Two head switches for distributor cap, air/liquid distributors, all sorts of air, air, gas, wind, air/liquid/gas compress, mixture air with lubricant, liquid, liquid of all sorts, mixture of air liquid, air/liquid cycle, air cylinders/containers, air (double) cylinders/containers with springs, air cylinders of 4 piece combinations, weight pressure of engine/vehicle, air cylinders with liquid/solid materials, air/liquid pressure, air carburetors, rotating pistons, rewind springs, brackets, brackets of carburetors, cables, accelerators, air adjustable bolts, air releasing bolts, air valves, key contacts, modified key contacts, springs of all forms, springs, shock absorbers, spring pressure, spring pumps, engines, motors, mini motors, flywheels, alternators/dynamos, powerful alternators, alter-motor(s), starters, kick starters, oil pumps, piston kits, pistons with rollers, piston handles, piston handles with groove parts, half gear axis, half gears, bars with groove parts, bearing having axis fixing between its center and rim, rollers of bars, cable rollers, shafts, connecting rod kits, complete bearing connecting rod kits, rollers fixed in wheel pushing by springs, bearings, chains, drives, engine valves, timing belts, pulleys, kick starters, batteries, air outlets of opening/closing by springs, (air) valves by air pressure, propeller blades, half covered blades, partial cover blades, speed acceleration blades, covers, switches, speedometers, speedometer switches, gear transmission handles, cable sets, air (hydraulic) units, thermostats, timing belts with pistons, gear axles, V. belts, air outlets, air channels, air openings, double radiators, engine electricity, electric wires, conductors, electric channels, extension, bracket springs, barriers, air filters, motor switches, handles with pistons, air meter switches, pumps, color lamps, air pipes, semi-circle brackets, adjustable air valves, electric motors, housing electricity, pipes, pedals, wheels, any other form wheels, springs pressing rollers outward for wheels, Motor spring engines, Air cycle substituting gasoline/diesel/gas in piston engines, Air cycle spring piston engines, Half gear roller piston spring engines, Draw roller piston spring engines, Alternator motoring engines, Air cycle vertical & horizontal piston/spring engines, Air cycle piston multiple angle spring engines, Air cycle engines/motors of tri-semicircle wheels, Air cycle engines/motors of cross-form wheels, Spring pump piston engines, Air spring pump engines of cross-form wheels, Air spring pump engines of navigation form wheels, Air cycle in piston engines, air cycle motors, engine of multiple energy, Spring piston engines, Spring pump engines, engine-cylinders, moving pedal of motor & engine systems, double radiator cooling system, air-conditioning engine system, motor & engine systems of speed, axis of blades for sailing ship, blade energy vehicles, blade energy trains, blade energy trolleys, blade energy underground trains, blade energy ships, invention for transportations of all sorts, motor & engine vehicles, cars, automobiles, trucks, buses, vans, trains, trolleys, underground trains, motorcycles, airplanes, helicopters, space rockets, missiles, ships, fleet, submarines, tractors, cultivators, generators, pumps, compressors, machineries, equipments, motors/engines of all sorts, moving objects of all sorts, spare parts, accessories.

### BRIEF DESCRIPTION OF THE SEVERAL VIEWS OF THE DRAWING

FIG. 1; “Duo ” Distributor cap of double connection (Duo-ddc)

FIG. 2; “Duo ” Air cylinder/container (Duo-ac.)

FIG. 3; “Duo ” Spring (air/liquid) pump (Duo-sp)

FIG. 4; “Duo ” Air cycle distributor (Duo-ad)

FIG. 5; “Duo ” Air carburetor (Duo-ac)

FIG. 6; “Duo ” Air cycle in piston engine

FIG. 7; “Duo ”: Air cycle substituting gasoline in piston engine

FIG. 8; Duo-E Air cycle spring in piston engine

FIG. 9; Duo-Ea Spring piston engine

FIG. 10; Duo-Eb Air cycle spring piston engine

FIG. 11; Duo-Ec Half gear roller piston spring engine

FIG. 12; Duo-Ed Draw roller piston spring engine

FIG. 13; Duo-Ee Draw roller piston spring engine

FIG. 14; Duo-Ef Motor spring engine

FIG. 15; Duo-Eg Air cycle vertical & horizontal piston/spring engine

FIG. 16; Duo-Eh Air cycle piston Multiple angle spring engine

FIG. 17; Duo-Eh to Ehh sorts of Multiple angle spring engine

FIG. 18; Duo-Ei Alternator motoring engine

FIG. 19; Duo-Ej Air cycle motor/engine of Tri-semicircle & Cross-form wheels

FIG. 20; Duo-Ej1 Air cycle engine of Tri-semicircle wheel

FIG. 21; Duo-Ej2 Air cycle engine of Tri-semicircle wheel

FIG. 22; Duo-Ek1 Air cycle engine of Cross-form wheel

FIG. 23; Duo-Ek Air Spring pump motor/engine of single Cross-form wheel

FIG. 24; Duo-Ek2 Spring pump piston engine

FIG. 25; Duo-Ek3 Air spring pump engine of Cross-form wheel

FIG. 26; Duo-El Air spring pump engine of Navigation form wheel

FIG. 27; Duo-El1 Air spring pump engine of Navigation form wheel

FIG. 28; Multiple energy in engine

FIG. 29; Engine network

FIG. 30; Duo-2s: 2 functions of motor and (gasoline/fuel) engine

FIG. 31; Duo-Sa Process of function a of speedometer switch & air meter indicator

FIG. 32; Duo-Sb Process of function b.

FIG. 33; Duo-Sb1 Pedals of motor & (gasoline/fuel) engine function

FIG. 34; Duo-Dr Double radiators of (gasoline/fuel) engine

FIG. 35; Duo-B1 Blade energy vehicle-1

FIG. 36; Duo-B2 Blade energy-2

FIG. 37; Duo-B3 Blade energy-3

FIG. 38; Duo-B4 Blade energy train-4

FIG. 39; Duo-B5 Blade energy train-5

FIG. 40; Duo-B6 Blade energy train-6

FIG. 41; Duo-B7 Blade energy train-7

FIG. 42; Duo-B8 Blade energy trolley or underground train-8

FIG. 43; Duo-B9 Blade energy on ship-9

FIG. 44; View of Duo-B9 Blade energy on ship

### DETAILED DESCRIPTION OF THE INVENTION

The invention is to make running without using energy or less energy for all kinds of transportations; engine-vehicles, motor-vehicles, cars, automobiles, trucks, buses, vans, trains, trolleys, underground trains, motorcycles, airplanes, helicopters, space rockets, missiles, ships, fleet, submarines, tractors, cultivators, generators, pumps, compressors, machineries, equipments, motors/engines of all sorts, and moving objects of all sorts by one(s) of the following elements and materials or equivalent modification:
Air cycle: Air, air compress, air pressure, air of all sorts, gas, air under low and high temperature of all circumstances using (in cycle) producing movement that air or air mixture with few lubricant is filled by compressing through air valve in air cylinder or container, spring is fixed at the end of cylinder pressing to produce force of movement concluding engine power.
Liquid cycle: Liquid compress, liquid of all sorts using (in cycle) producing movement that liquid or mixture of air liquid is filed by compressing through valve in liquid cylinder or container, air/liquid is supported under pressure of piston having heavy weight of liquid/solid material inside or engine/vehicle weight to produce force of air movement concluding engine power.
Pump: Spring pump, air pump, pumps of all sorts; direct pumping or pumping under intermediate of air or liquid, pumping force concluding engine power.
Spring force: Spring, shock absorber, spring pressure, springs of all forms are used producing movement that spring(s) is fixed in engine repulsing to create force of movement, spring force concluding engine power.
Adding extra alternators/dynamos charging battery generating alternating current powerful enough for motor running that extra alternators are equipped in engine charging battery largely for motor concluding engine power to rotate running replacing gasoline or fuel.
Adding partial cover blades blown by wind at open sides rotating speed acceleration blades that partial cover blades and speed acceleration blades are made one rotating side of blade as arrow head form for smooth spin equipped in vehicle for accelerating speed enforcing engine power and saving energy.

The invention creates structures of motors and engines to meet different requirements, gasoline/diesel motors and engines may be modified by replacement of parts adapting in use, based on the invention elements and fundamentals, modification of parts in engines equipping for all uses.

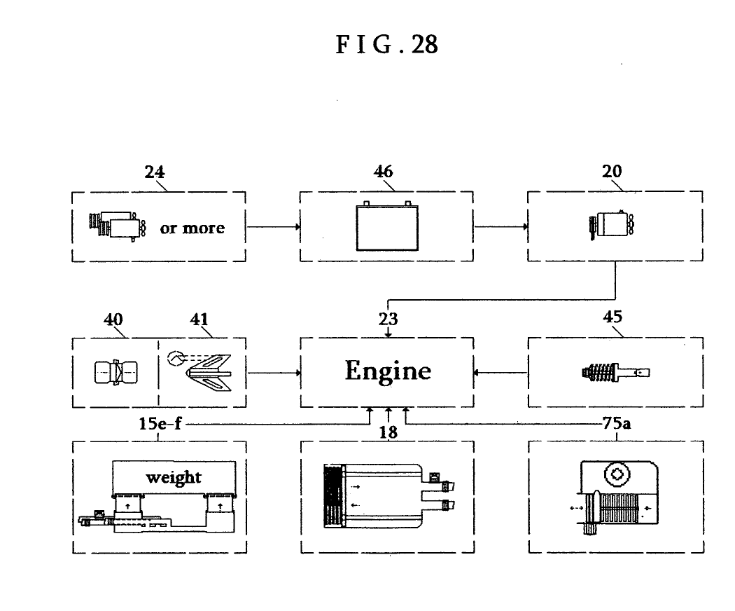

Multiple energy in engine: Engine 23; more alternators 24 are for largely charging battery 46 generating alternating current to motor 20 running, springs 45 are equipped repulsing motoring, air 18 produces compress air from air cylinder under spring force to create force of movement, weight 15e-f of vehicle, engine or objects under air pressure makes air moving, pump 75a is for pumping air or liquid against wheels of all forms for rotating engine, half covered blade 40 blown by wind rotates accelerating blade 41 for accelerating speed in vehicle on FIG. 28.

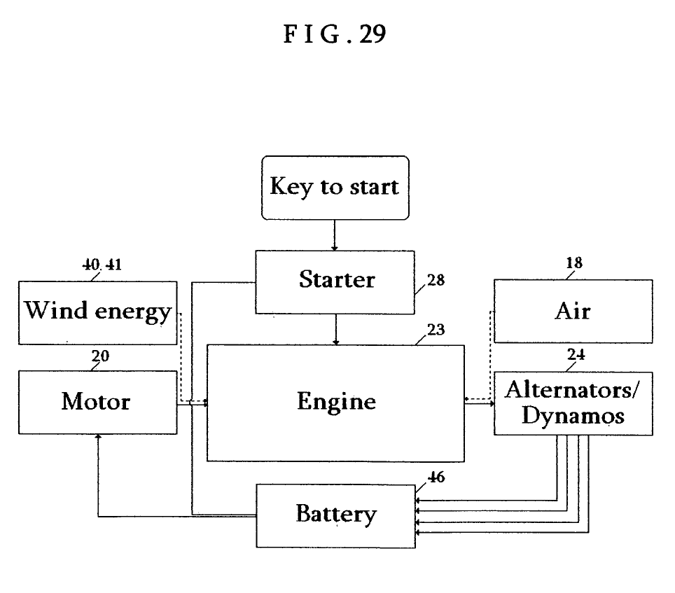

Engine network: Key to start is to switch starter 28 on, alternators 24 are for largely charging battery 46 to motor 20 for rotating, air 18 produces compress air from air cylinder to create force of movement for rotating engine 23, half covered blade 40 blown by wind rotates accelerating blade 41 for accelerating speed in vehicle on FIG. 29.

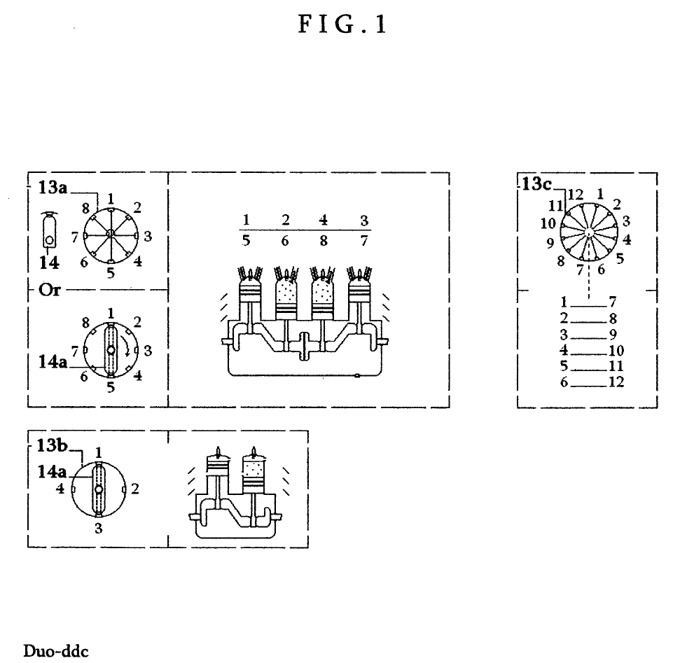

FIG. 1; “Duo” Distributor cap of double connection: Cap of distributor has double current connection for passing current two times or more to a same spark plug in a circle of engine for accelerating speed and power that a 16 valve-8 piston engine will be replaced by a 8 valve-4 piston engine in a 8 position distributor cap (1 to 8) at equivalent speed power for costing less. Distributor cap 13a of 8 positions with switch 14 and two head switch 14a with a 8 position distributor cap have 4 connections to spark plugs separately, switch 14a for distributor cap 13b in 2-stroke engine and 12 (1 to 12) positions (1-7, 2-8, 3-9, 4-10, 5-11, 6-12) in distributor cap 13c for gasoline, diesel and gas engines.

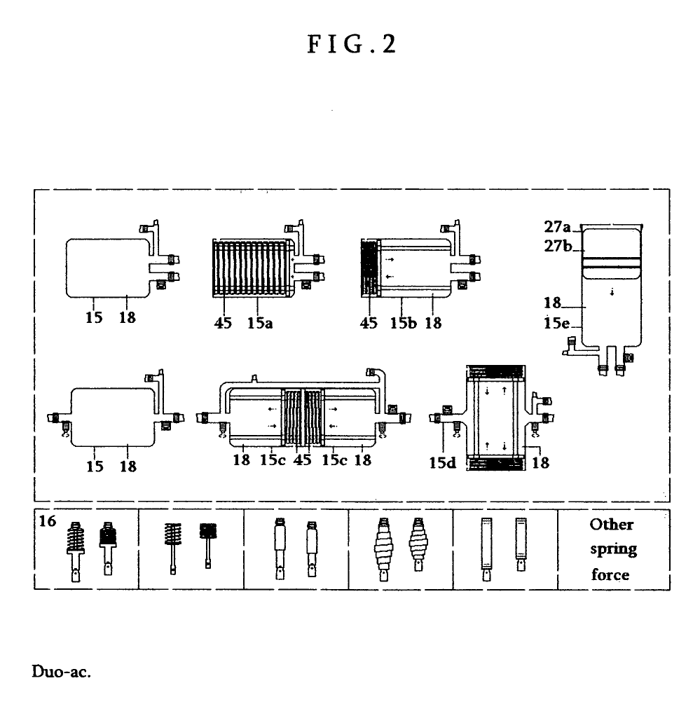

FIG. 2; “Duo” Air cylinder/container: Air produces movement in cycle by air compress and/or spring force concluding engine power that air or air mixture with/without few lubricant is filled by compressing through air valve in air cylinder/container: air 18 in air cylinder 15, air cylinder 15a; spring 45 is fixed at the end of cylinder pressing for producing maximum force of movement by air 18 in engine, air cylinder 15b with spring 45 under air 18 pressure, air double cylinder 15c with two springs 45 under air pressure 18, air cylinder 15d with air 18, air cylinder 15e in which air 18/liquid is supported under pressure of either piston 27a having heavy weight of liquid/solid material 27b inside or that of engine/vehicle concluding engine power to produce force of movement to air. Shock absorbers and springs 16 of all sorts in use.

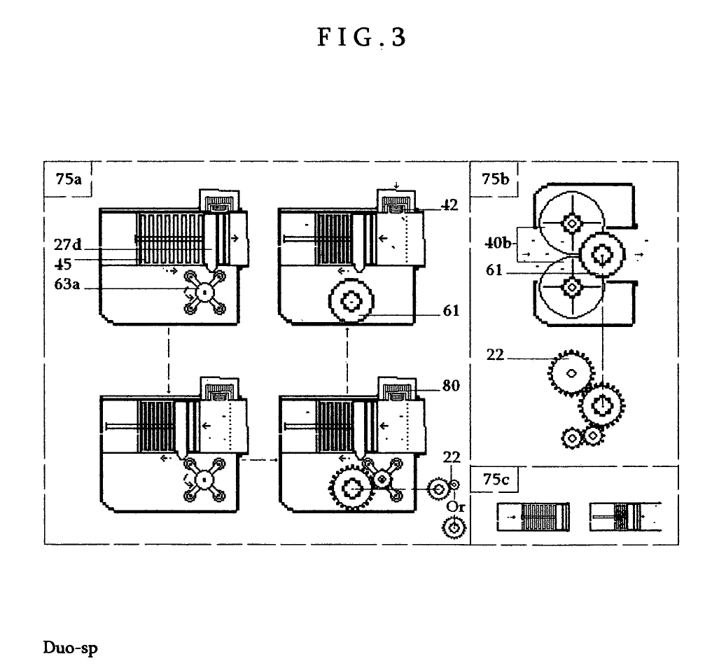

FIG. 3; “Duo” Spring (air/liquid) pump: Spring pump is to be equipped rotating by motor or engine for pumping; pump 75a: It has piston 27d with ring, air filter 80, spring opening outlet 42, spring 45 is fixed at the end of cylinder to pump by spring force, a 4-roller wheel 63a is linked with gears 22 and pulley 61 to switch piston unit moving forward and backward pumping rotated by engine. Air pump 75b: It has two half covered blades 40b linked with gears 22 and pulley 61, blades rotate wind blowing through between 2 blades to engine without possessing anti-rotating force. Pump 75c: Spring force repulses.

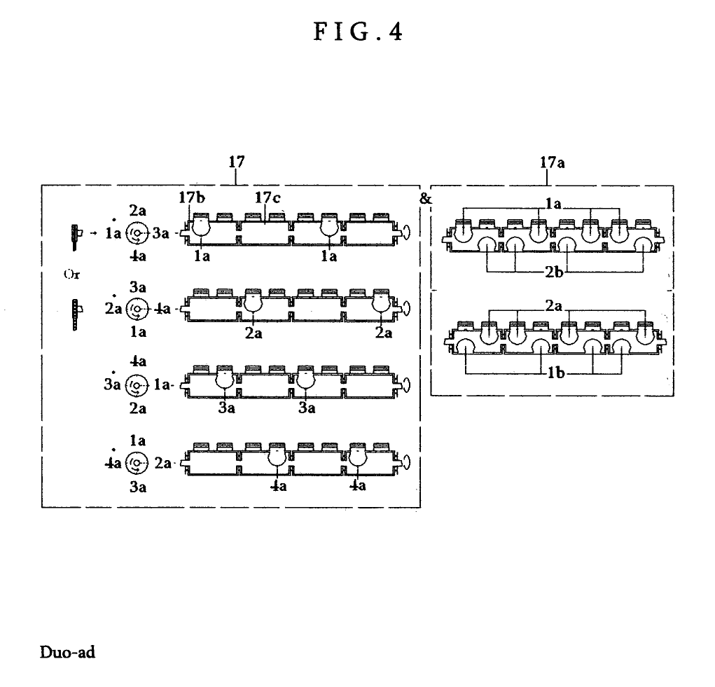

FIG. 4; “Duo” Air cycle distributor: Air distributor is placed as intermediate device between carburetor and engine for distributing air to cylinder timely by engine spin of timing belt & pulley or chain & drive. Piston tube 17c contains 4 parts in cylinder 17b of air distributor 17, each part has 2 outlets rotating by turn; air from air cylinder comes to press engine piston down through an opening outlet of 1a while air is pushed up to air cylinder by next piston through the other opening outlet of 1a or turn of 2a, 3a and 4a set. Air distributor 17a shows opening 1a & closing 2b outlets or closing 1b & opening 2a outlets.

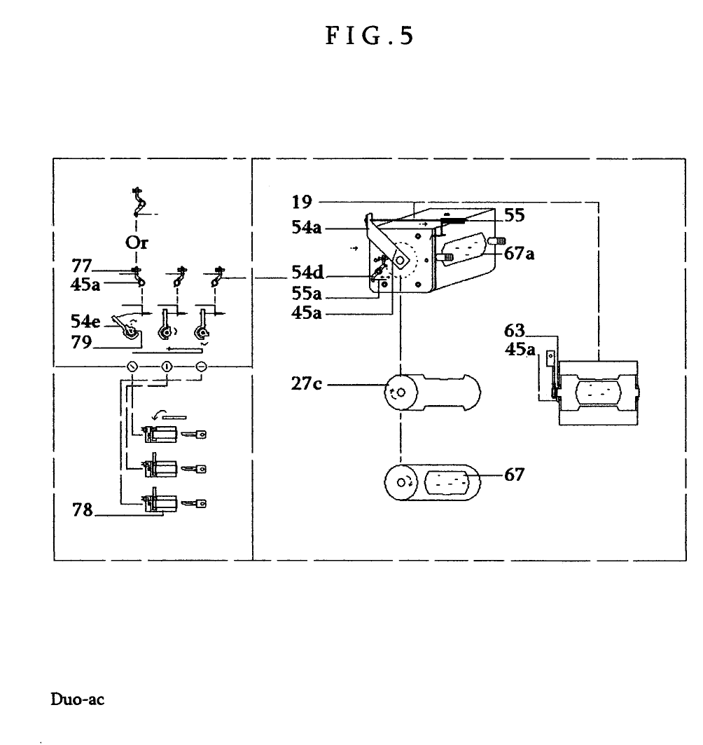

FIG. 5; “Duo” Air carburetor: Air carburetor 19 is made particularly for air/liquid cycle engine, it has a rotating piston 27c fixed to its bracket 54a with rewind spring 45a linked with cable 55 to accelerator, its piston has a center opening part 67 by where air passes through it on spin against outlet 67a of carburetor, air will cease passing whenever piston opening 67 is rotated against carburetor body, rotating piston with/without rollers 63 is by drawing its bracket under function of accelerator, vehicle speed depends quantity of air pushing to engine on wide or narrow opening of piston spin, the bracket 54d with rewind spring 45a has air adjustable bolt 77, engine is switched off by cable 55a drawing proper bracket set 54d from bracket 54e by key contact 78 on spin of inner key roller 79 at specific side to close air current.

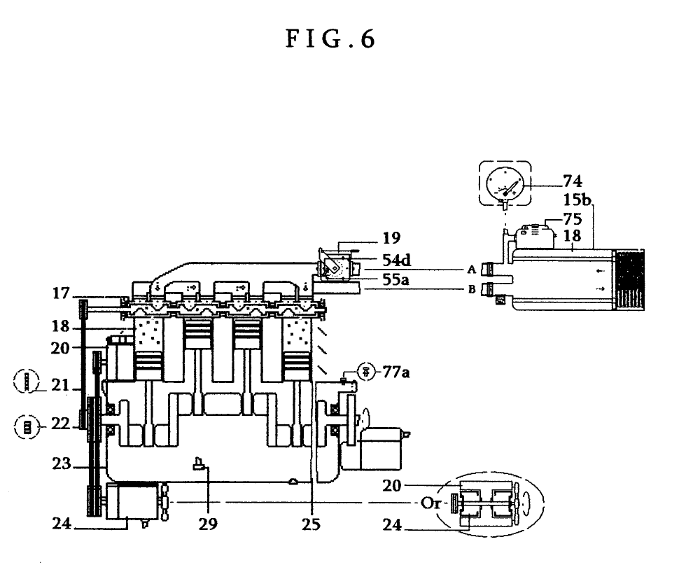

FIG. 6; “Duo” Air cycle in piston engine: Key to start by starter, motor 20 rotates shaft, connecting rod kit, timing belt 21, pulley 22, air distributor 17 that air 18 is pressed from air cylinder 15b through outlet A, carburetor 19 into cylinder of engine 23 pushing piston kits down while other two piston kits up push air back to air cylinder/container 15b through outlet B keeping engine running, engine axle is for connecting to transmission box, oil pump 29 for lubricating, alternators 24, air meter switch 74 to driver, air pump 75, battery, spare parts are connected, carburetor is functioned by driver's accelerator, engine is switched off by cable 55a drawing proper adjustable bracket set 54d of carburetor to close air current on spin of key contact, engine with air releasing bolt 77a may be prolonged 25, modification of parts in engines equipping for all uses.

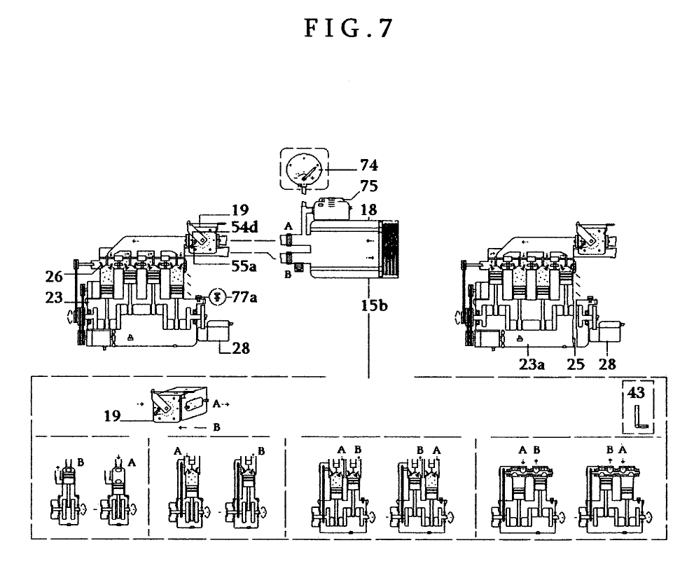

FIG. 7; “Duo”: Air cycle substituting gasoline/fuel in piston engine: Key to start by starter 28 or kick starter 43, engine 23 rotates shaft, connecting rod kit, timing belt & pulley or chain & drive to turn either air distributor or engine valves 26 for distributing air 18 from air cylinder 15b through outlet A, carburetor 19 into cylinder pushing piston kits down while other two piston kits up push air back to air cylinder/container 15b through outlet B keeping engine running, once pointer of driver 's air meter switch 74 drops below level, air pump 75 on pumps air to air cylinder, engine axle is for connecting to transmission box, oil pump for lubricating, alternators, battery, spare parts are equipped, engine carburetor is functioned by driver 's accelerator and switched off by cable 55a drawing proper adjustable bracket 54d to close air current on spin of key contact, engine 23a with air releasing bolt 77a may be prolonged 25, modification of parts in engines equipping for all uses.

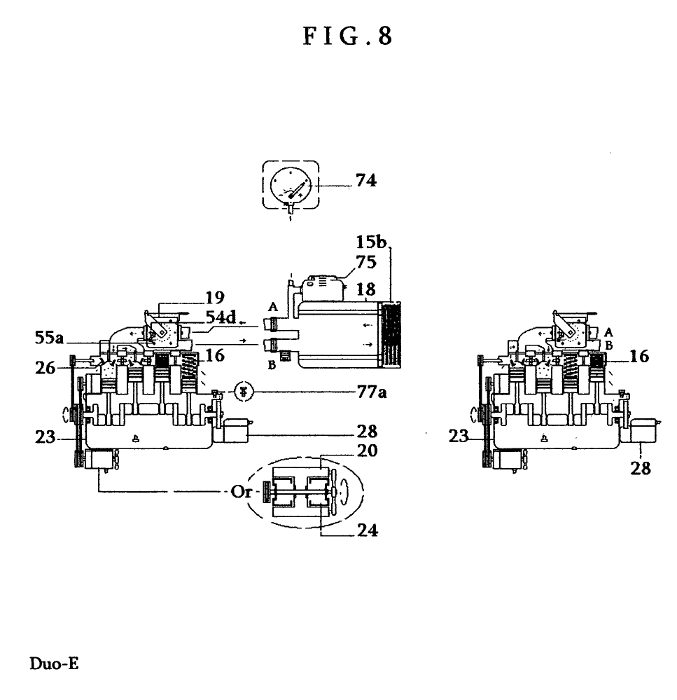

FIG. 8; Duo-E Air cycle spring in piston engine: Key to start by starter 28, motor 20 rotates shaft, connecting rod kit, pulley of timing belt for either opening/closing of valves 26 or air distributor that air 18 is pressed from air cylinder 15b through outlet A, carburetor 19 into cylinder pushing piston kits down while next piston kits up push air by spring force 16 back to air cylinder/container 15b through outlet B keeping engine running, once pointer of driver's air meter switch 74 drops below level, air pump 75 on pumps air to air cylinder, engine axle is for connecting to transmission box, oil pump for lubricating, alternators 24, battery, spare parts, engine carburetor is functioned by driver's accelerator and switched off by cable 55a drawing proper bracket 54d to close air current on spin of key contact, engine 23 with air releasing bolt 77a may be prolonged, modification of parts in engines equipping for all uses.

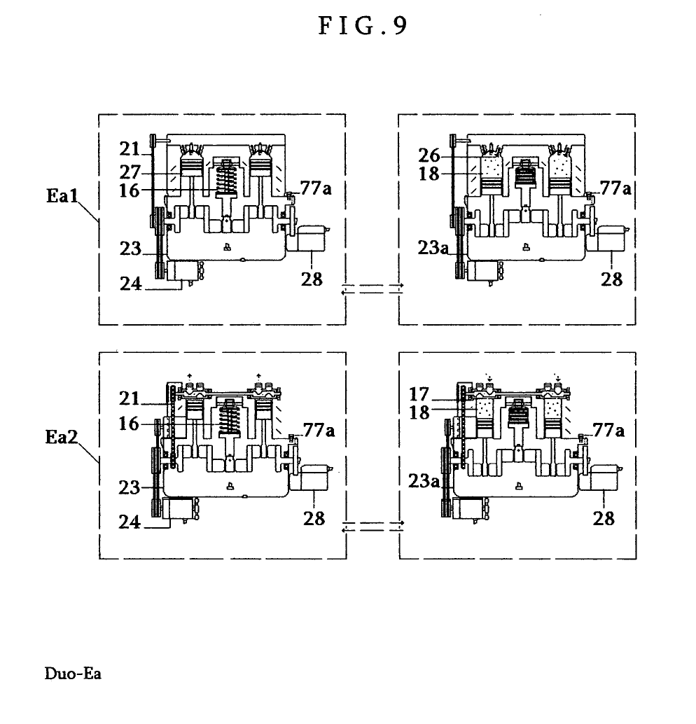

FIG. 9; Duo-Ea Spring piston engine: Key to start by starter 28, engine 23 & 23a rotates shaft, connecting rod kit, timing belt 21 pulley or chain & drive 21 for turning either air distributor 17 or engine valves 26 that air 18 and/or liquid cycle is pressed from air cylinder through pipe, carburetor into cylinder down pushing piston kits 27, it will up repulse air back to air cylinder/container through other pipe under spring 16 force in place of two pistons to keep engine running, engine axle is for connecting to transmission box in vehicle, oil pump for lubricating, alternators 24, battery, spare parts are equipped, carburetor is functioned by driver's accelerator, engine with air releasing bolt 77a is switched off to close current of air carburetor on spin of key contact in Ea1 of air, gasoline, diesel, gas engines & Ea2, modification of parts in engines equipping for all uses.

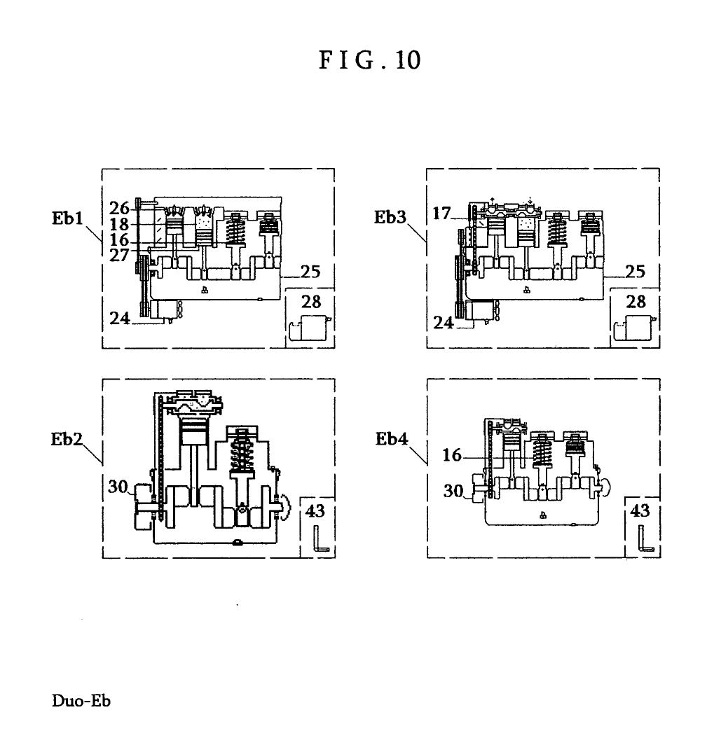

FIG. 10; Duo-Eb Air cycle spring piston engine: Key to start by either starter 28 (Ed1, Eb3) or kick starter 43 (Ed2, Eb4), engine rotates timing belt & pulley or chain & drive turning either air distributor 17 (Eb3) or engine valves 26 (Eb1) for distributing air 18 and/or liquid in cycle from air cylinder/container through pipe, carburetor into cylinder down pushing piston 27, it will up repulse air back to air container through other pipe under spring 16 force to keep engine running, engine axle is for connecting to transmission box in vehicle, alternators 24 or flywheels 30 charging battery largely generating alternating current, oil pump for lubricating, engine carburetor is functioned by driver's accelerator and switched off to close air current on spin of key contact in Eb1 (gasoline, diesel, gas engines) to Eb4, engine with air releasing bolt may be prolonged 25, modification of parts in engines equipping for all uses.

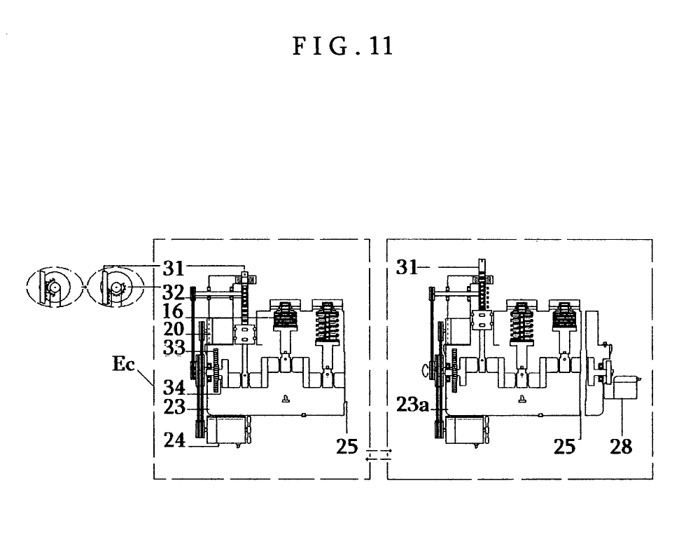

FIG. 11; Duo-Ec Half gear roller piston spring engine: Engine is invented running without using gasoline, fuel that key to start by starter 28, motor 20 rotates a large gear 33 against a smaller one 34 for accelerating speed in engine 23 & 23a, it turns a timing belt with pulley of axis whose half gear 32 at end part engages groove part of a piston handle 31 moving up and down by engine motor as main function, spring 16 repulses keeping engine running, alternators 24 charge battery largely generating alternating current for motor, engine axle for connecting to transmission box in vehicle, oil pump for lubricating, engine is switched motor off by key contact, engine with air releasing bolt may be prolonged 25 in Ec, modification of parts in engines equipping for all uses.

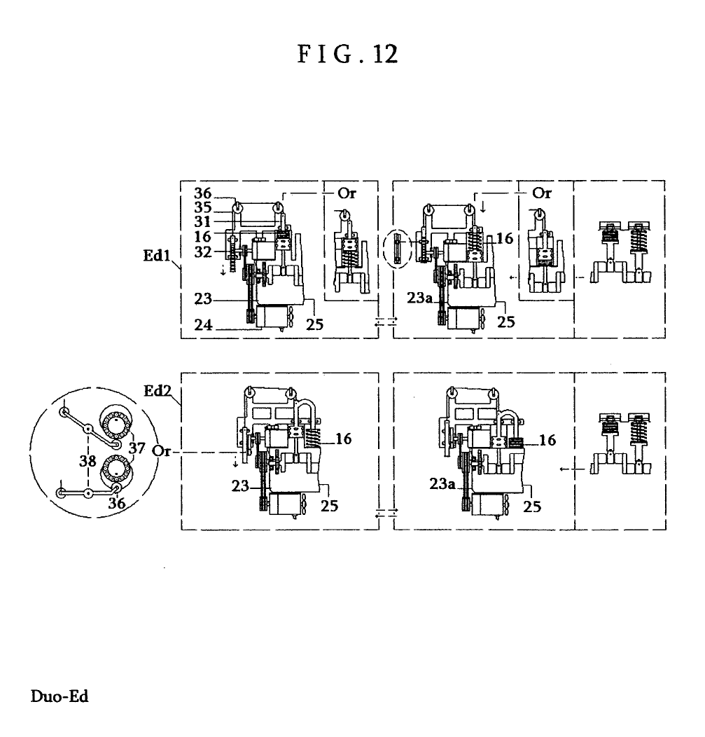

FIG. 12; Duo-Ed Draw roller piston spring engine: Key to start by starter, motor rotates a large gear against a smaller one in engine 23 & 23a, it turns a timing belt, pulley with either a half gear 32 of axis engaging groove part of a bar (Ed1) or a bearing 37 fixing axis between its center and rim part circling to press on roller 36 of bar 38 (Ed2) moving up and down to draw piston handle 31 by cable 35 roller under spring 16 in slighter force, alternators/dynamos 24 charge battery largely generating alternating current for motor use, engine axle for connecting to transmission box in vehicle, oil pump for lubricating, engine is switched motor off by key contact, engines may be prolonged 25, modification of parts in engines equipping for all uses.

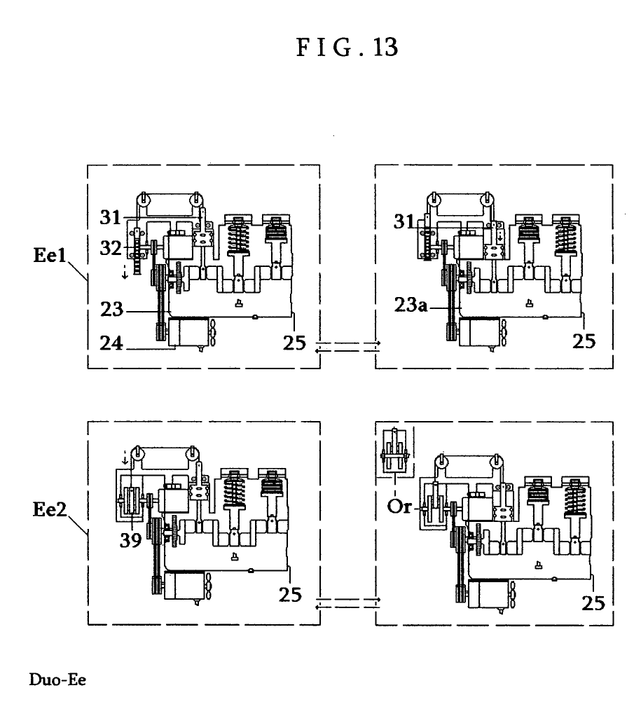

FIG. 13; Duo-Ee Draw roller piston spring engine: Key to start, motor rotates a large gear against a smaller one in engine 23 & 23a, it turns a timing belt, pulley with either a half gear 32 of axis engaging groove part of a bar (Ee1) or a complete bearing connecting rod kit 39 (Ee2) moving up and down to draw piston handle 31 in slighter manner by cable roller under spring repulsed force, alternators/dynamos 24 charge battery largely generating alternating current for motor use, engine axle for connecting to transmission box in vehicle, oil pump for lubricating, engine is switched off by key contact, engines may be prolonged 25, modification of parts in engines equipping for all uses.

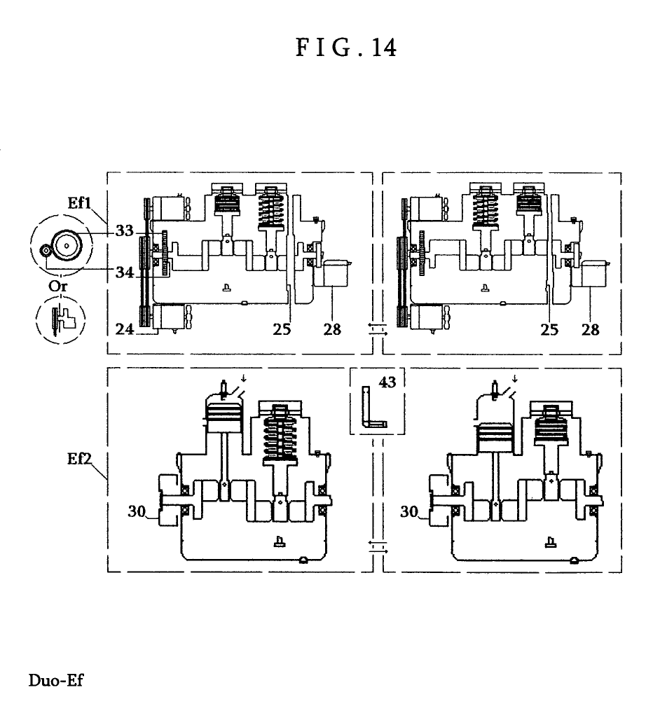

FIG. 14; Duo-Ef Motor spring engine: Key to start by either starter 28 (Ef1) or kick starter 43 (Ef2), motor rotates a large gear 33 against a smaller one 34, springs repulse to keep engine running, flywheel 30, alternators/dynamos 24 charge battery largely generating alternating current for motor, engine axle for connecting to transmission box in vehicle, oil pump for lubricating, engine is switched off by key contact in Ef1, Ef2 of gasoline, gas, diesel engines, engine with air releasing bolt may be prolonged 25, modification of parts in engines equipping for all uses.

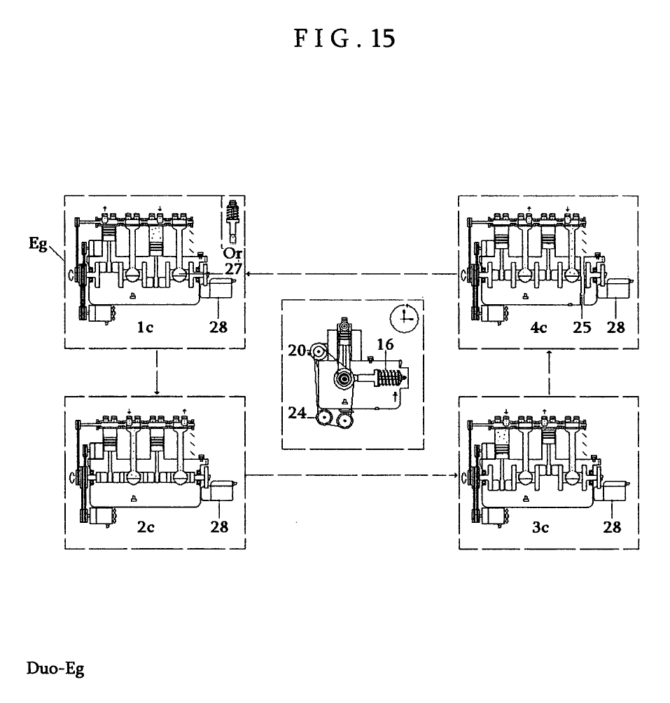

FIG. 15; Duo-Eg Air cycle vertical & horizontal piston/spring engine: Key to start by starter 28, engine rotates timing belt, pulley, air and/or liquid distributor for distributing air from air cylinder or container through pipe, carburetor into cylinder down pushing piston kit which will up repulse air back to air cylinder by turns through other pipe to keep engine running, either piston 27 or spring 16 is placed horizontally pushing engine shaft on the half way of circle for accelerating speed shown on 1c to 4c, engine axle is for connecting to transmission box in vehicle, oil pump for lubricating, alternators/dynamos 24 with/without motor 20, engine carburetor is functioned by driver's accelerator and switched off by cable drawing proper bracket to close air current on spin of key contact, engine with air releasing bolt may be prolonged 25, modification of parts in engines equipping for all uses.

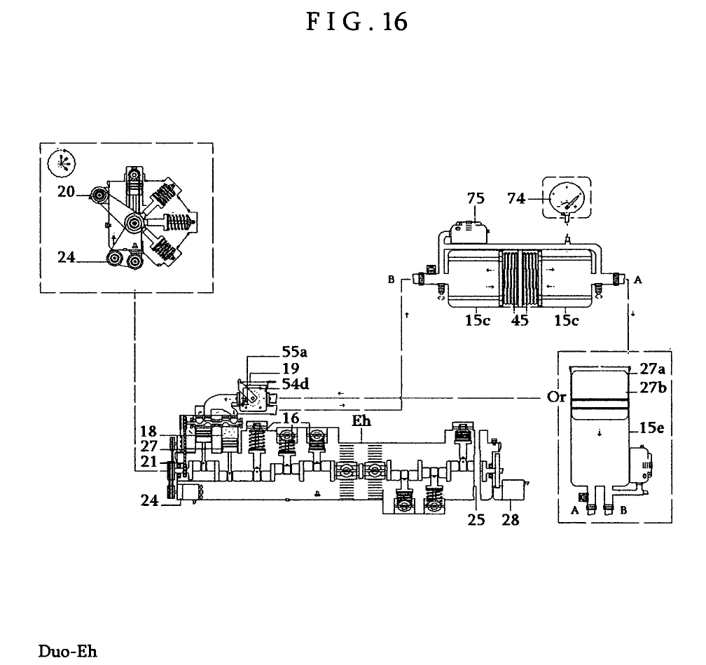

FIG. 16; Duo-Eh Air cycle piston multiple angle spring engine: Key to start by starter 28, engine rotates drive & chain 21, air and/or liquid distributor for distributing air 18 from air cylinder 15c/15e under spring 45 pressure or under piston 27a pressure having heavy weight of inner liquid/solid material 27b through pipe A, carburetor 19, into cylinder down pushing piston 27 which will up repulse air back to air cylinder by turns through pipe B and springs/shock absorbers 16 are equipped repulsing to keep engine running being placed pushing engine shaft on every possible angle for accelerating speed in a circle shown on figure, once pointer of driver 's air meter switch 74 drops below level, air pump 75 on pumps air to air cylinder, engine axle is for connecting to transmission box in vehicle, alternators 24 with/without motor 20, oil pump for lubricating, engine carburetor is functioned by driver's accelerator and switched off by cable 55a drawing proper bracket set 54d to close air current on spin of key contact, the bracket has air adjustable bolt, engine with air releasing bolt may be prolonged 25 as desirable, modification of parts in engines equipping for all uses.

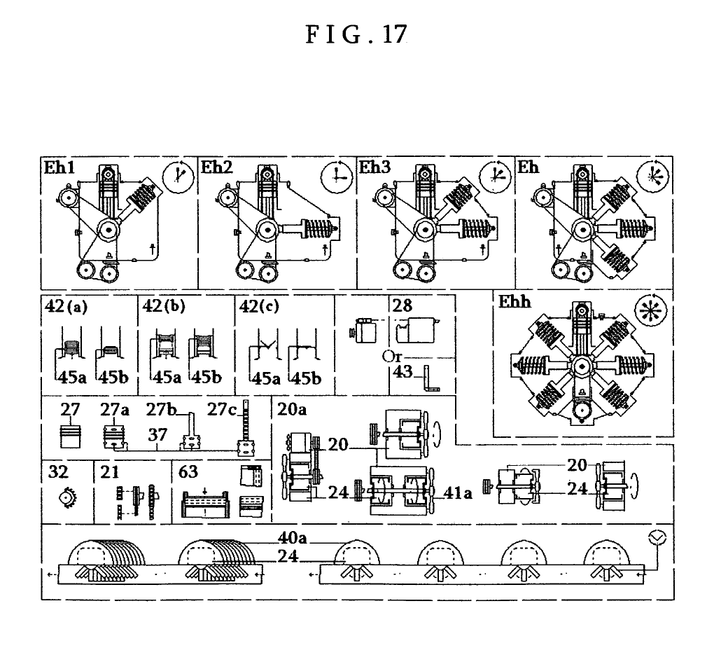

FIG. 17; Duo-Eh to Ehh sorts of Multiple angle spring engine: Engine springs are placed at every possible angle to push engine shaft for accelerating speed in a circle shown on figure. Eh1: Two pistons, spring(s)/shock absorber(s) positioning at 45 degrees, Eh2: Two pistons, spring(s) at 90 degrees, Eh3: Two pistons, spring(s) at 45, 90 degrees, Eh: Two pistons, spring(s) at 45, 90 & 135 degrees, Ehh: Two pistons, at 7 spring positions, necessary parts to make engine running, timing belts 21 of all sorts, air outlets: 42(a) to 42(c); its opening 45a by air, its closing 45b by spring force, starter 28, kick starter 43, alter-motor 20a; combination of alternator(s) 24 & motor(s) 20 with/without blade(s) 41a, piston 27, pistons 27a to 27c including rollers 37 fixed in piston for moving smoothly, half gear 32, roller fixed in wheel pushing by springs 63. Half covered blades 40a or equivalents with dynamos 24 are equipped at open sides along moving air/liquid channels to generate electricity.

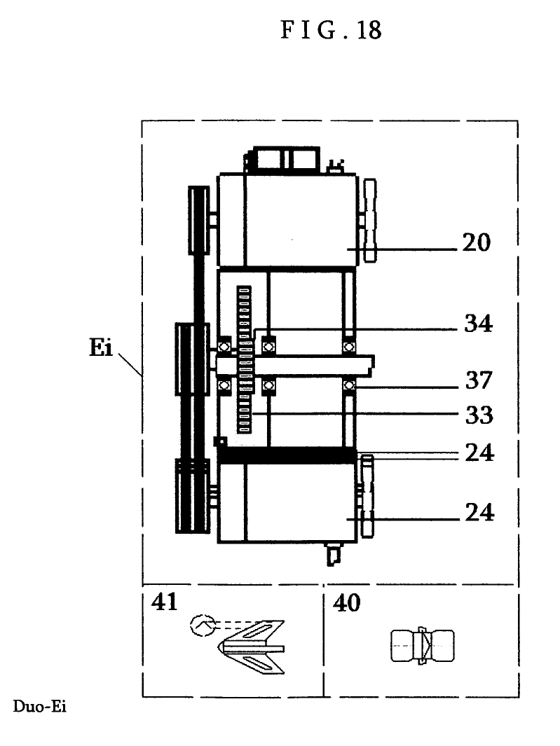

FIG. 18; Duo-E1 Alternator motoring engine: Key to start, motor 20 rotates a large gear 33 against a smaller one 34, three or more alternators/dynamos 24 charge battery largely generating alternating current for motor, engine axle is equipped with bearings 37 for connecting to transmission box in vehicle, half covered blades 40 are installed with accelerating speed blades 41 blown by wind power during vehicle running, motor speed is functioned by driver's accelerator and switched off by key contact, modification of engine parts equipping for all uses.

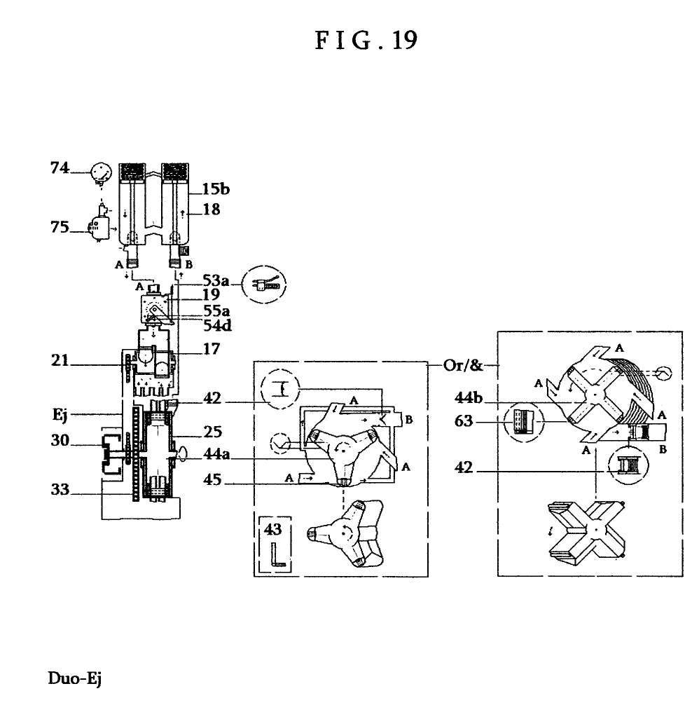

FIG. 19; Duo-Ej Air cycle motor/engine of Tri-semicircle & Cross-form wheels: Key to start by starter 43, flywheel 30 rotates timely drive & chain 21, motor, air distributor 17 for distributing air 18 from spring pressure air cylinder/container 15b through pipe A, carburetor 19, towards openings A for rotating Tri-semicircle wheel 44a or Cross-form wheel 44b in motor/engine whose outlets B have air valve 42 with opening by air pressure, one side of wheels is made as arrow head form, springs 45 pressing rollers 63 are fixed outer wheels for rotating smoothly, once pointer of driver's air meter switch 74 drops below level, air pump 75 on pumps air to air container 15b, gear 33 is for connecting to transmission gear, equipping battery, adjustable bracket of carburetor is functioned by driver's accelerator 53a, motor is switched off by cable 55a drawing proper bracket set 54d of carburetor to close air current on spin of key contact, motor/engine 25 extendable, modification motor/engine parts equipping for all uses.

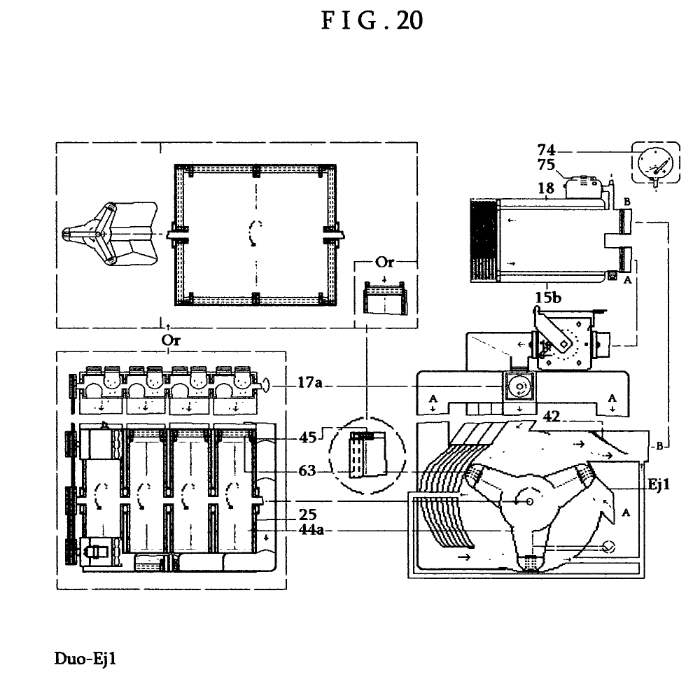

FIG. 20; Duo-Ej1 Air cycle engine of Tri-semicircle wheel: Key to start, motor rotates engine, timing belt, pulley, air/liquid distributor 17a for distributing air 18 from air cylinder under spring pressure 15b through pipe A, carburetor towards three openings A of per unit for rotating a tri-semicircle wheel 44a in engine whose outlet B has air valve with opening 42 by air pressure, one side of wheel is made as arrow head form for smooth spin, rollers 63 pressed by springs 45 are fixed outer and two sides of tri-semicircle wheel rotating, once pointer of driver's air meter switch 74 drops below level, air pump 75 on pumps air to air cylinder, alternator(s)/dynamo(s) for largely charging battery, engine axle for connecting to transmission box in vehicle, engine carburetor is functioned by driver's accelerator and switched off by cable drawing proper bracket of carburetor to close air current on spin of key contact, the bracket has adjustable bolt, engine may be prolonged 25, modification of parts in engines equipping for all uses.

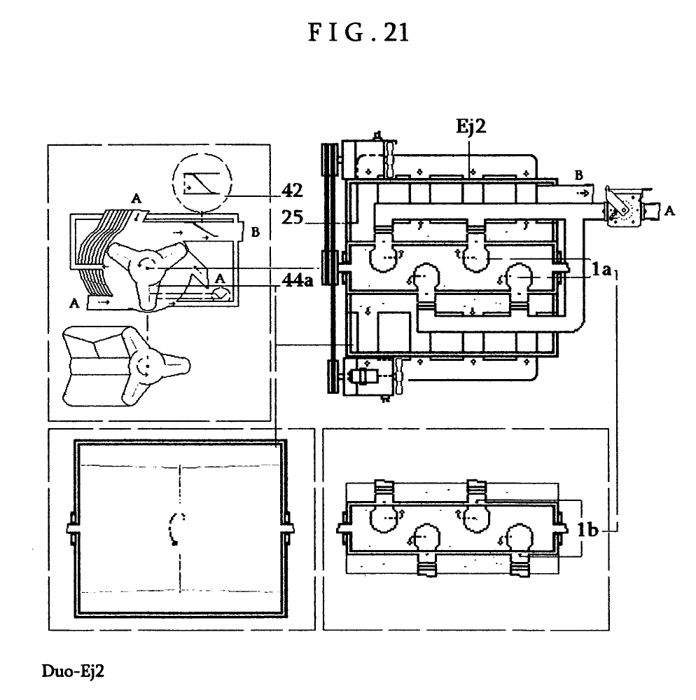

FIG. 21; Duo-Ej2 Air cycle engine of Tri-semicircle wheel: Key to start, motor rotates timing belt, pulley, engine and air and/or liquid distributor of opening la or its closing 1b that air is from air cylinder/container through pipe A, carburetor towards openings A of per unit for rotating a tri-semicircle wheel 44a in engine whose outlet B has air valve 42 with opening by air pressure, one side of wheel is made as arrow head form for smooth spin, once pointer of driver's air meter switch drops below level, air pump on pumps air to air cylinder, end of engine axle is for connecting to transmission box in vehicle, alternators/dynamos for largely charging battery generating alternating current, engine carburetor is functioned by driver's accelerator and switched off by cable drawing proper bracket having air adjustable bolt to close air current on spin of key contact, engine may be prolonged 25, modification of parts in engines equipping for all uses.

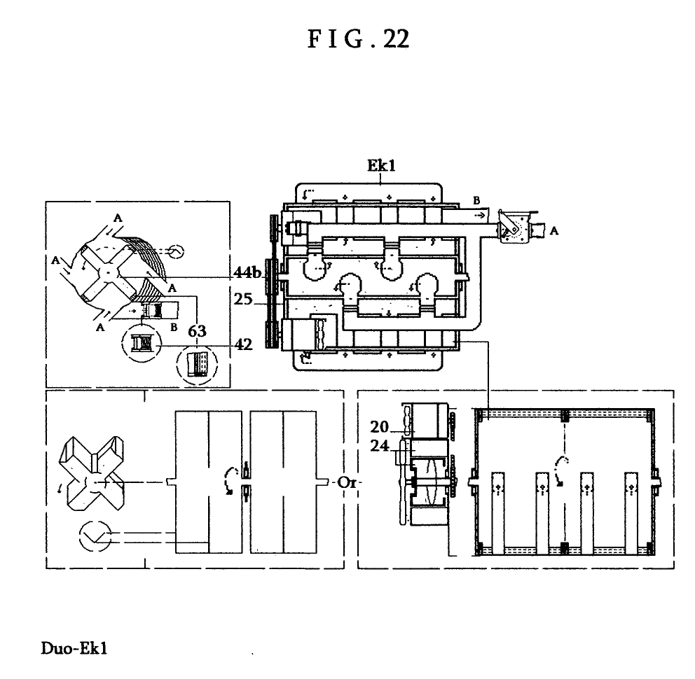

FIG. 22; Duo-Ek1 Air cycle engine of Cross-form wheel: Key to start, motor 20 rotates engine, timing belt, pulley and air distributor of opening that air is from spring pressure air cylinder/container through pipe A, carburetor towards four openings A of per unit for rotating a cross-form wheel 44b in an engine whose outlet B has air valve 42 with opening by air pressure, one side of wheel is made as arrow head form for smooth spin, rollers 63 pressing by springs are fixed outer wheel rotating smoothly, once pointer of driver's air meter switch drops below level, air pump on pumps air to air cylinder, engine axle is for connecting to transmission box in vehicle, alternator(s) 24 for largely charging battery, engine carburetor is functioned by driver's accelerator and switched off by cable drawing proper bracket of carburetor to close air current on spin of key contact, the bracket has air adjustable bolt engine may be prolonged 25, modification of parts in engines equipping for all uses.

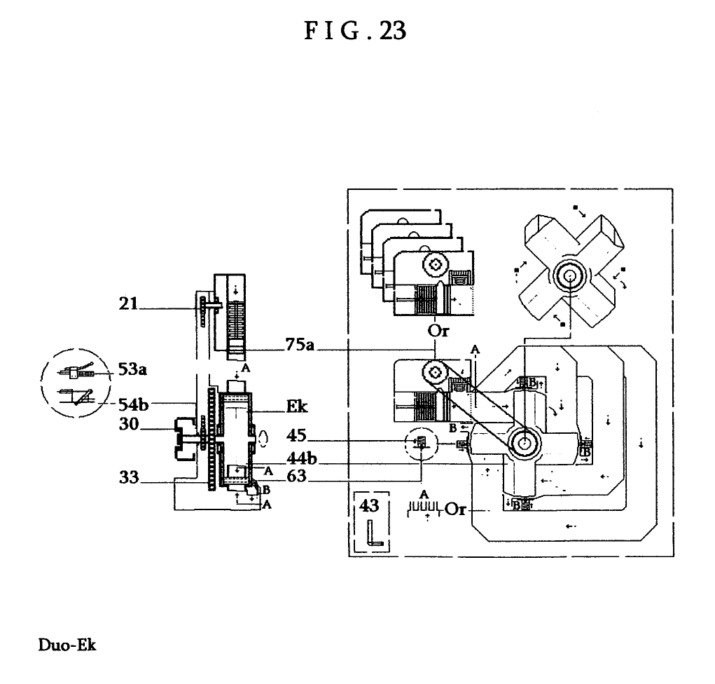

FIG. 23; Duo-Ek Air Spring pump engine/motor of single cross-form wheel: Key to start by starter 43, flywheel 30 rotates timely drive & chain 21, spring pumps 75a for pumping air to motor 4 openings rotating a cross-form wheel 44b through pipes A, air will blow out through pipes B, one side of wheel is made as arrow head form for smooth spin, rollers 63 pressing by springs 45 are fixed on motor against inner wheel point for air pumping effect, gear 33 is for connecting to transmission gear, equipping battery, adjustable bracket 54b of flywheel is functioned by driver's accelerator 53a and switched off by key contact, modification of parts in engine/motor equipping for all uses.

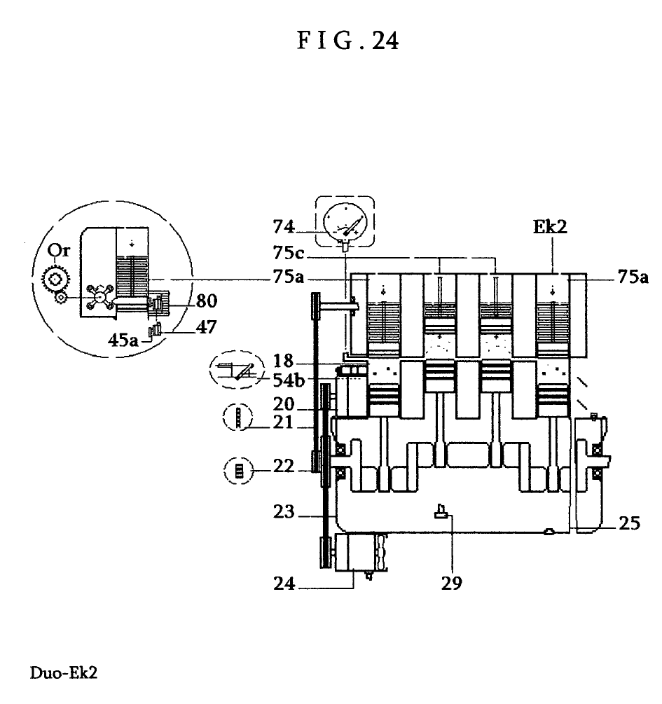

FIG. 24; Duo-Ek2 Spring pump piston engine: Key to start, motor 20 rotates engine 23, connecting rod kit, shaft, pump 75a and 75c with timing belt 21, pulley 22, air 18 was filled up keeping in cylinder as intermediate between pistons of pump and engine, pumps are placed vertically for pumping pushing pistons down that two pumps 75a are rotated by engine spin, two middle spring pumps 75c repulse, first pump has a mini-motor 47 with rewind spring 45a to be reacted button switch by air meter switch 74 to open pump outlet pumping air under air filter 80 at volume once its pointer drops below level, motor speed and pumping conclude engine power, alternator(s) 24 for charging battery, oil pump 29 for lubricating, engine axle for connecting to transmission box in vehicle, motor adjustable bracket 54b is functioned by driver's accelerator and switched motor off by key contact, engine with air releasing bolt may be prolonged 25, modification of parts in engines equipping for all uses.

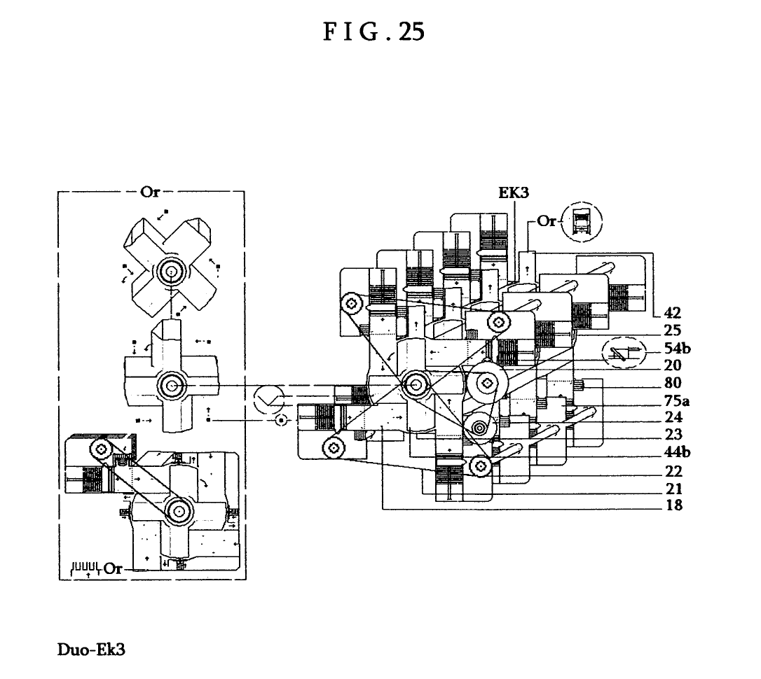

FIG. 25; Duo-Ek3 Air spring pump engine of cross-form wheel: Key to start, motor 20 rotates engine 23, pump with timing belt 21, pulley 22, air 18 passes through air filter 80 of pump 75a for pumping air to flat part of either cross-form wheels 44b or any other form wheels on spin, one side of wheel is made as arrow head form for smooth spin, either spring pumps or 4 center spring pumps linked with air pipes being placed at different angles pumping maximum air possible concluding engine power, engine has outlets 42 with air valves opening by air pressure, engine axle is for connecting to transmission box in vehicle, alternator(s)/dynamo(s) 24 for charging battery, motor adjustable bracket 54b is functioned by driver's accelerator and switched off by key contact, engine may be prolonged 25, modification of engine parts equipping for all uses.

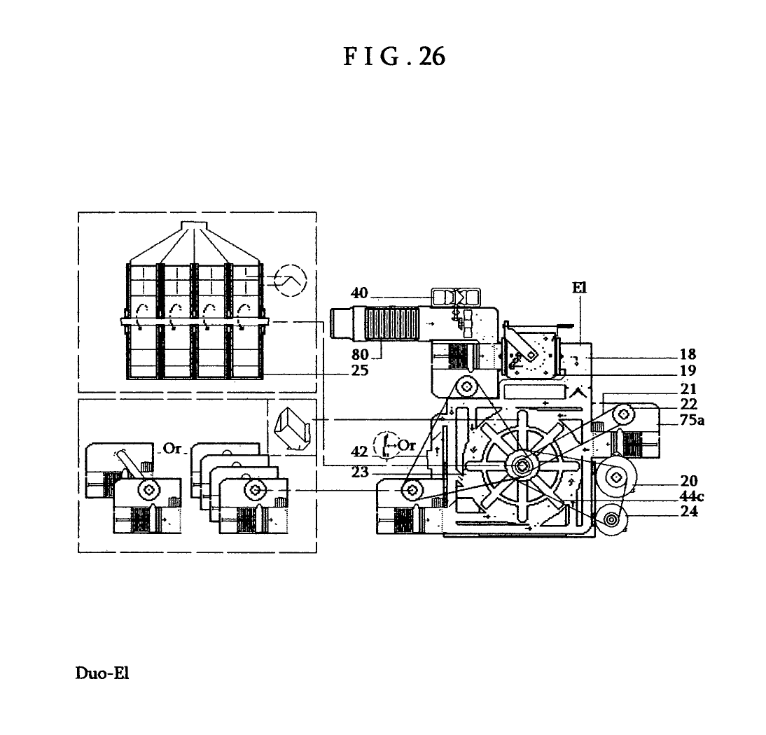

FIG. 26; Duo-E1 Air spring pump engine of navigation form wheel: Key to start, motor 20 rotates engine 23, pump 75a with timing belt 21, pulley 22, air 18 passes through air filter 80, half covered blade 40, pump, air carburetor 19 for pumping air to flat part of either navigation form wheels 44c or any other form wheels on spin, one side of wheel is made as arrow head form for smooth spin, either spring pumps or 4 center spring pumps linked with air pipes being placed at different angles pumping maximum air possible concluding engine power, engine has outlets 42 with air valves opening by air pressure, end of engine axle is for connecting to transmission box in vehicle, alternator(s)/dynamo(s) 24 for charging battery, adjustable bracket of carburetor is functioned by driver's accelerator, engine is switched motor off by cable drawing proper bracket of carburetor to close air current on spin of key contact, engine may be prolonged 25, modification of engine parts equipping for all uses.

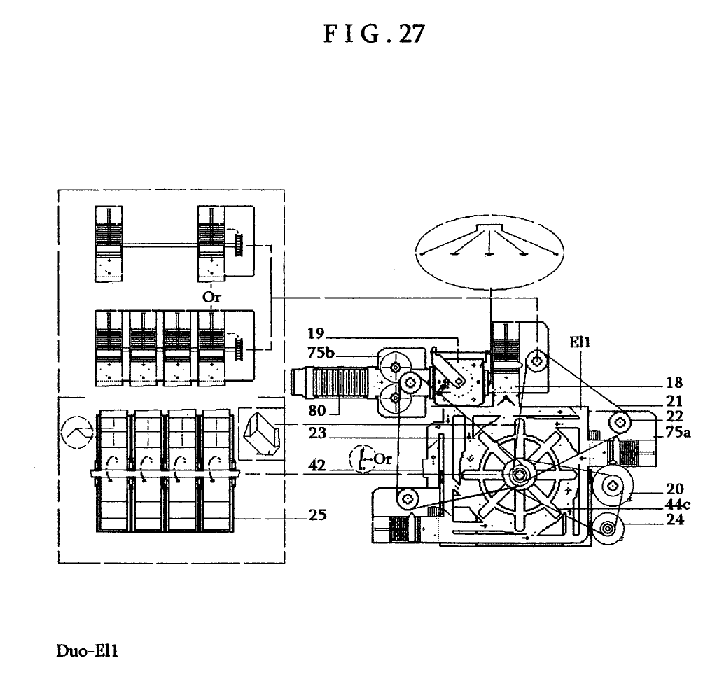

FIG. 27; Duo-El1 Air spring pump engine of navigation form wheel: Key to start, motor 20 rotates engine 23, spring pump 75a with timing belt 21, pulley 22, air 18 passes through air filter 80, pump 75b, air carburetor 19 for pumping air to flat part of either navigation form wheels 44c or any other form wheels on spin, one side of wheel is made as arrow head form for smooth spin, either spring pumps or 4 center spring pumps linked with air pipes being placed at different angles pumping maximum air possible concluding engine power, engine has outlets 42 with air valves opening by air pressure, end of axle is for connecting to transmission box in vehicle, alternator(s)/dynamo(s) 24 for charging battery, adjustable bracket of carburetor is functioned by driver's accelerator and switched motor off by cable drawing proper bracket of carburetor to close air current on spin of key contact, engine may be prolonged 25, modification of engine parts equipping for all uses.

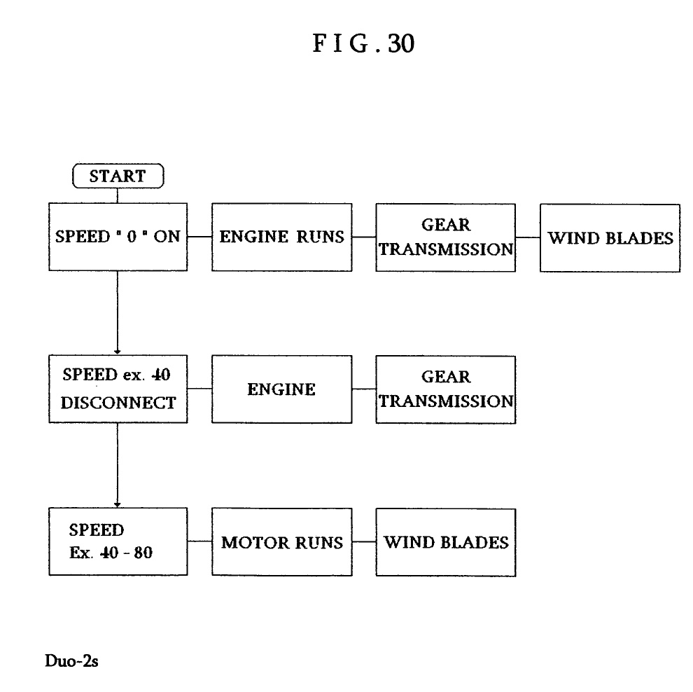

FIG. 30; Duo-2s; 2 functions of motor and (gasoline/diesel) engine: Energy blades are equipped in transportation of all sorts running in two systems to save gasoline and reduce air pollution particularly for gasoline engine. Engine starts running at speed of “0”, whenever it reaches speed superior to “40”, it will disconnect engine by speedometer switch switching gear transmission into “0” point by mini motor that vehicle runs by energy blades rotating extra alternator(s) charging battery to generate a separate motor running, the motor is connected with pulley of axle linked to front wheels.

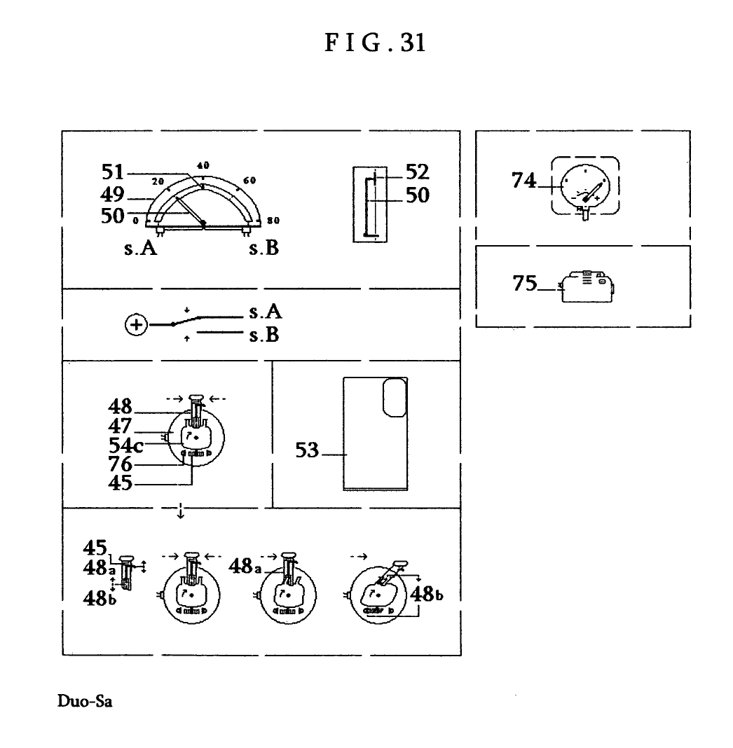

FIG. 31; Duo-Sa Process of function a of Speedometer switch & Air meter switch: Speedometer is used as a switch in which speedometer indicator 49 is divided into two parts; “0 to 40” and “40 to 80” under isolation 51, each part is connected electrically to its proper operation, speedometer pointer 50 conducts on indicator (rear) surface 52 for turning on either “A” or “B” system based on car speed (or air pressure). Speedometer will switch system on to change speed between “0” and running point of transmission handle that mini motor 47 engages with semi-circle bracket 54c pressing on bar moving up 48a and down 48b for changing transmission moving forward and backward, the bar is half covered in gear transmission handle 48 for locking gear below, bracket spring 45 pushes to barrier 76 positioning for bar descending, switches are installed to turn motor off at point, accelerator 53 is adjustable in (gasoline/diesel) engine. Air meter switch: once pointer of driver's air meter switch 74 drops below level with color lamp flashing, air pump 75 on pumps air to air cylinder.

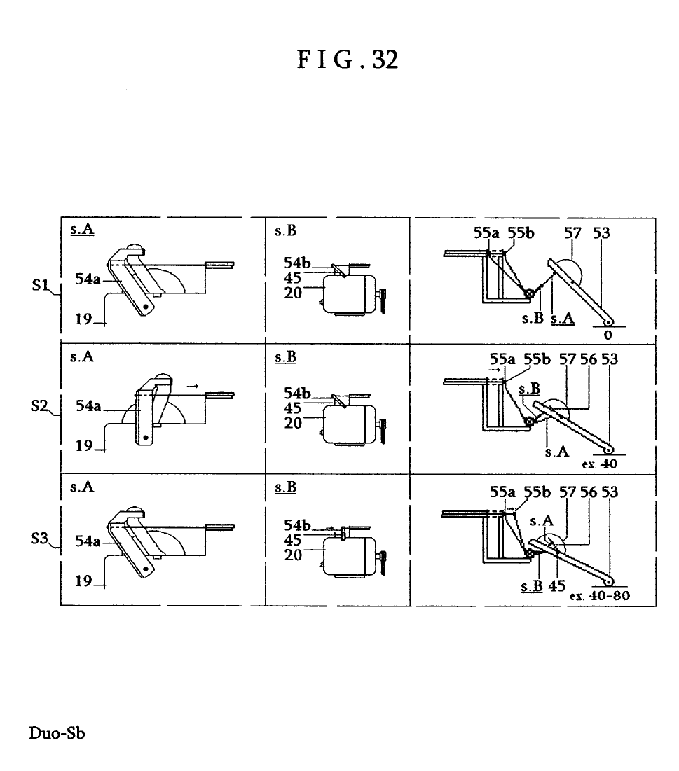

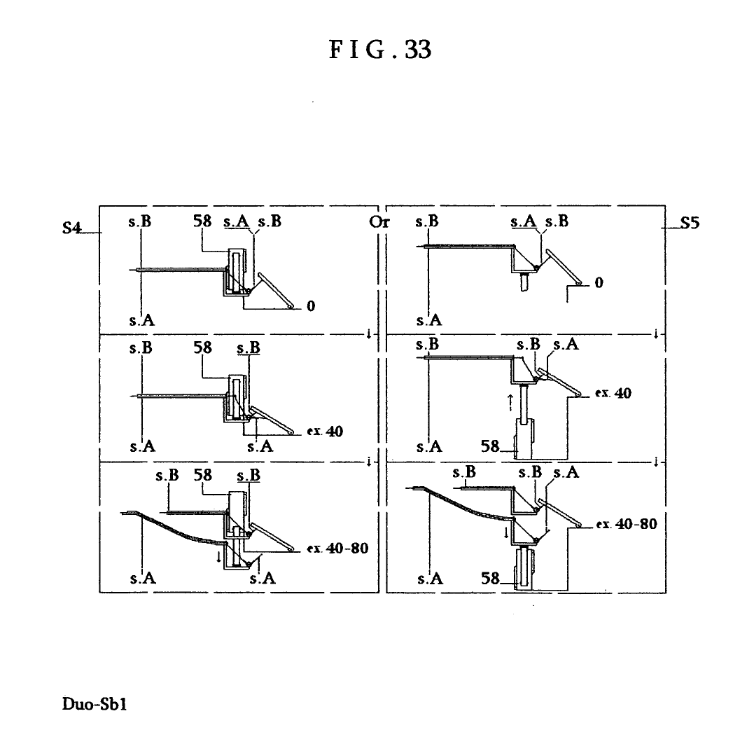

FIG. 32; Duo-Sb Process of function b: Speed below “40”; pedal 53 is pressed s. A for drawing bracket 54a of carburetor 19 by cable set 55a on S1 to S2 system A. Speed above “40”; pedal 53 is being pressed deeper s. B for drawing bracket 54b at motor 20 with spring 45 by cable set 55b on S3 system B. Bar of brake pedal s. A hits spring pressing pedal piece 56 up rising progressively that bracket of carburetor moves back to original position, this pedal piece can be moved up and down with adaptable spring pressure 45 under cover 57 on 40-80 degree. FIG. 33; Duo-Sb1 Pedals of motor & engine function: Speedometer is used as a switch to switch air (hydraulic) unit 58 for rising pedal up and down functioning based on A or B system on S4 or S5 in (gasoline/diesel) engine.

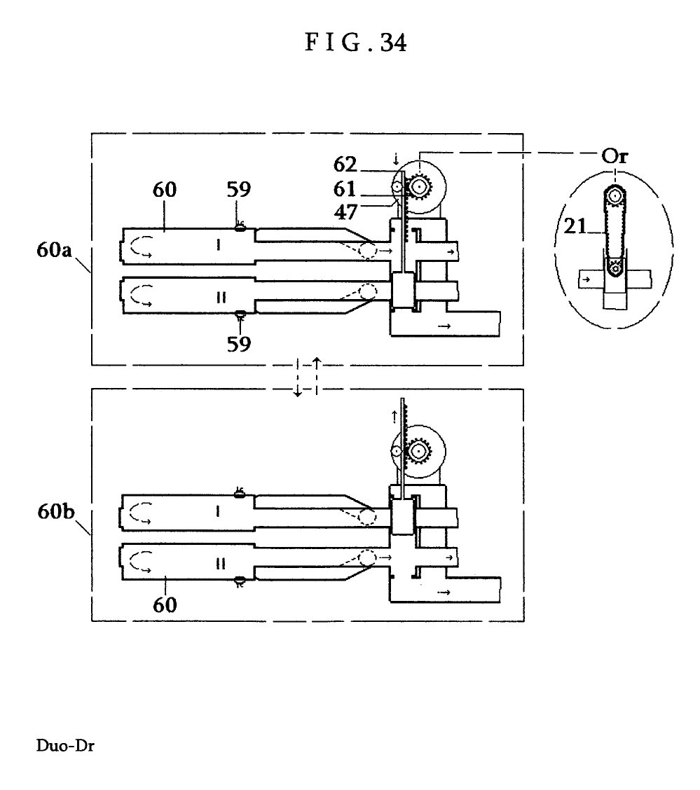

FIG. 34; Duo-Dr Double radiators of (gasoline/diesel) engine: Cooling system with extra radiators for engine, thermostat 59 is fixed reacting a mini motor 47 for closing one radiator 60 of hot water and opening the other one(s) of cool water based on specific heating temperature alternatively for vehicle long running. Mini motor 47 rotates gear 61 to elevate either handle with piston 62 or timing belt 21 with piston from one radiator to the other(s) on 60a and 60b, switches are installed to turn mini motor off at point. Or using air-conditioning system in engine.

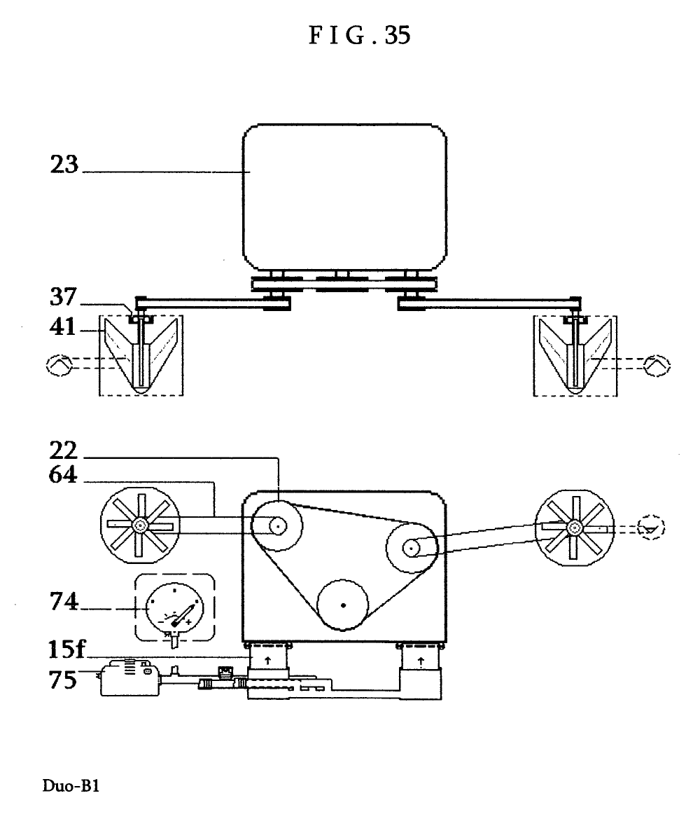

FIG. 35; Duo-B1 Blade energy vehicle-1: Speed acceleration blades 41 are equipped with bearings 37 rotating pulley 22, V. belt 64 by car engine 23 for accelerating speed. Air cylinder 15f of 4 piece combination is filled up by air compressing to support weight of either engine or vehicle as pressure on transportation of all sorts concluding engine power to form force of air movement, it is connected to air pump 75 and air meter switch 74.

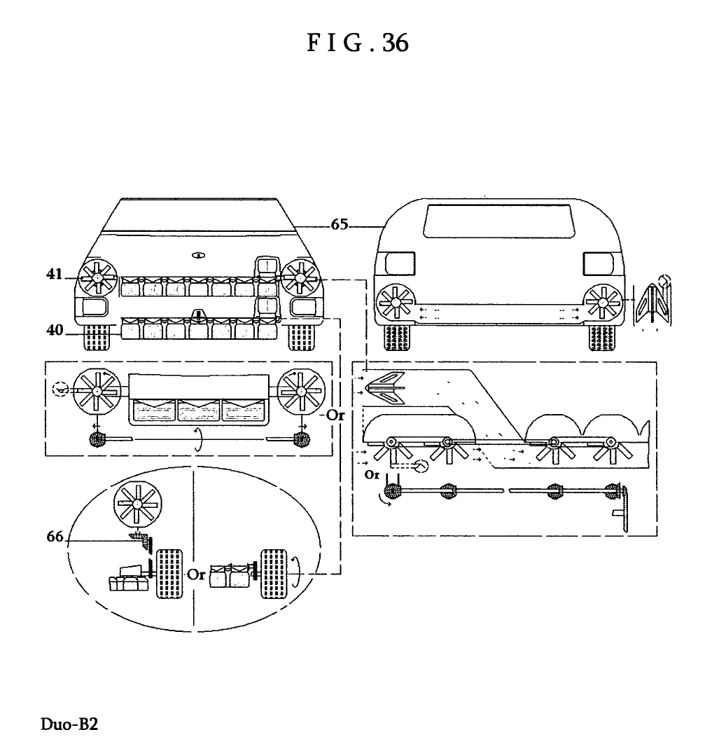

FIG. 36; Duo-B2 Blade energy-2: Speed acceleration blades 41 are installed at both sides in front and rear parts of vehicle 65 for accelerating speed, wind blows at rear blades through channel from front, it blows at open sides of half covered blades 40 connected to accelerating speed blades, with gears 66 or V. belts & pulleys.

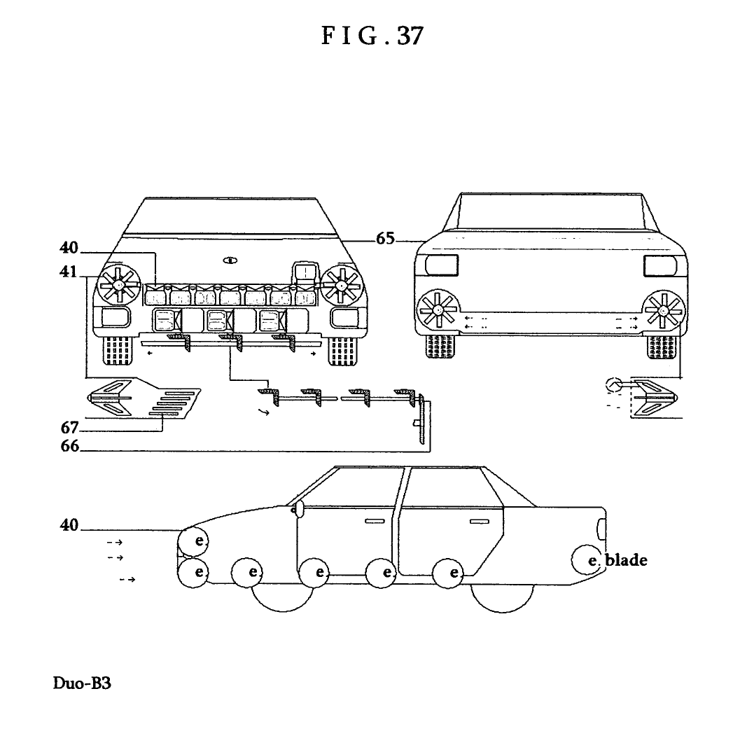

FIG. 37; Duo-B3 Blade energy vehicle-3: Speed acceleration blades 41 are installed at both sides in front and rear parts of vehicle 65 having wind outlet 67, wind blows at rear blades through channel front, it blows at open sides of half covered blades 40 connected to accelerating speed blades with gears 66 or V. belts & pulleys for accelerating speed. Car may be equipped maximum (energy) e. blades using minimum energy.

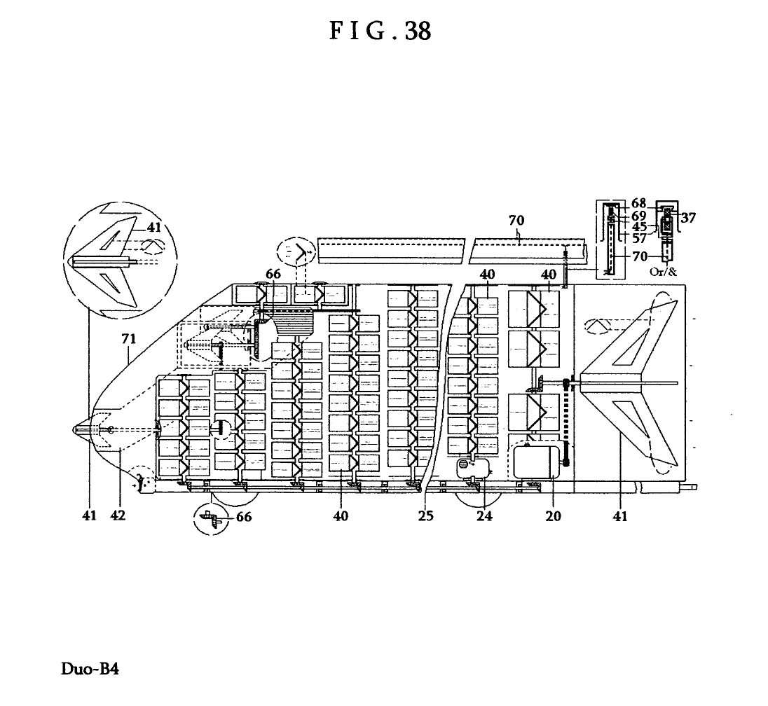

FIG. 38; Duo-B4 Blade energy train-4: Half covered blades 40 are equipped with gears 66 blowing by wind power at open sides for rotating alternators/dynamos 24 to generate electricity train 71 and speed acceleration blades 41 to accelerate train speed during running under gear 66 connection, air channel 42 leads to air outlet, motor 20 turns blade periodically, electric wire 70 is linked through spring 45 with either conductor 69 or ball bearing 37 to electric wire channel 68 with cover 57, cutting 25 shows train extension.

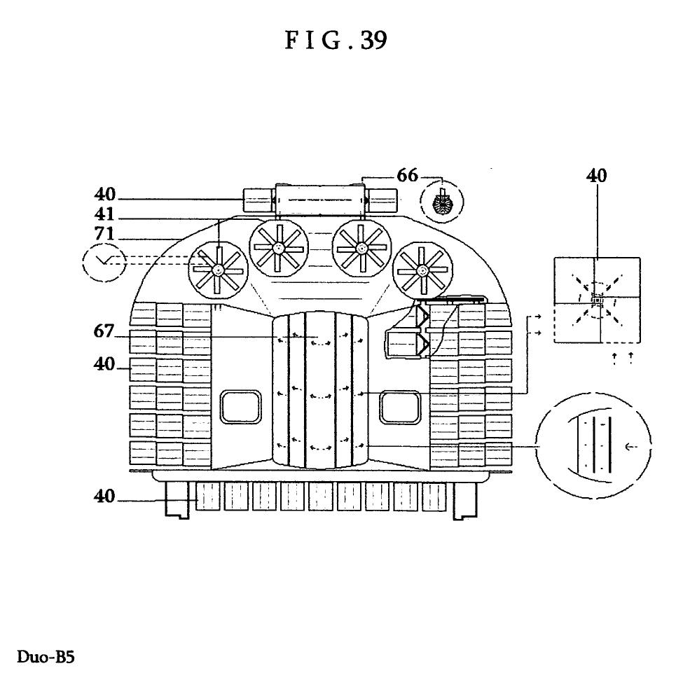

FIG. 39; Duo-B5 Blade energy train-5: Half covered blades 40 are equipped in front train gaining maximum space of wind blowing power at open sides for rotating alternators/dynamos to generate alternating current in train 71 and for rotating speed acceleration blades 41 to accelerate speed under gear 66 connection during train running, wind will blow through openings 67 of its head part center onto opening sides of half covered blades 40 for empowering spin.

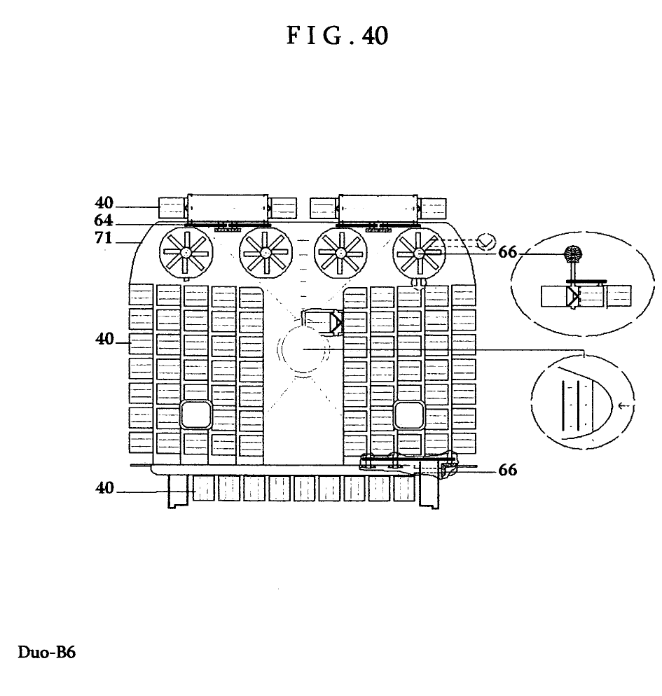

FIG. 40; Duo-B6 Blade energy train-6: Half covered blades 40 are equipped in front train gaining maximum space of wind blowing at open sides for rotating alternators/dynamos to generate alternating current in train 71 and for rotating speed acceleration blades 41 to accelerate speed during train running under gear 66, V. belt 64 connection.

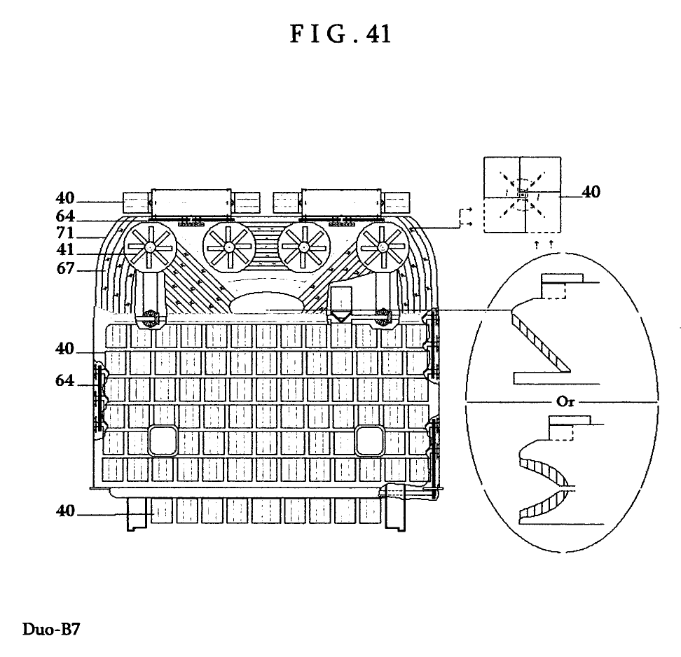

FIG. 41; Duo-B7 Blade energy train-7: Half covered blades 40 are equipped in front train obtaining maximum space of wind blowing for rotating alternators/dynamos to generate alternating current in train 71 and speed acceleration blades 41 to accelerate speed during train running under gear, V. belt 64 connections, wind will blow through openings 67 of its upper part onto opening sides of half covered blades 40 for empowering spin.

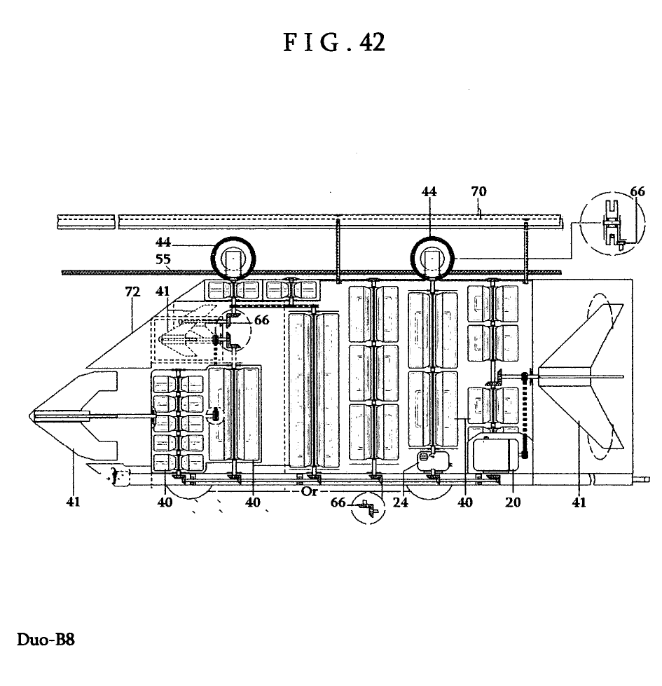

FIG. 42; Duo-B8 Blade energy trolley and underground train-8: Half covered blades 40 are equipped blowing by wind power for rotating alternators/dynamos 24 to generate alternating current in trolley 72, underground train and speed acceleration blades 41 to accelerate speed under gear 66 connection, electric wires 70 are connected to electric channel, motor 20 turns speed blade 41 periodically, wheels 44 roll on cable 55 for trolley.

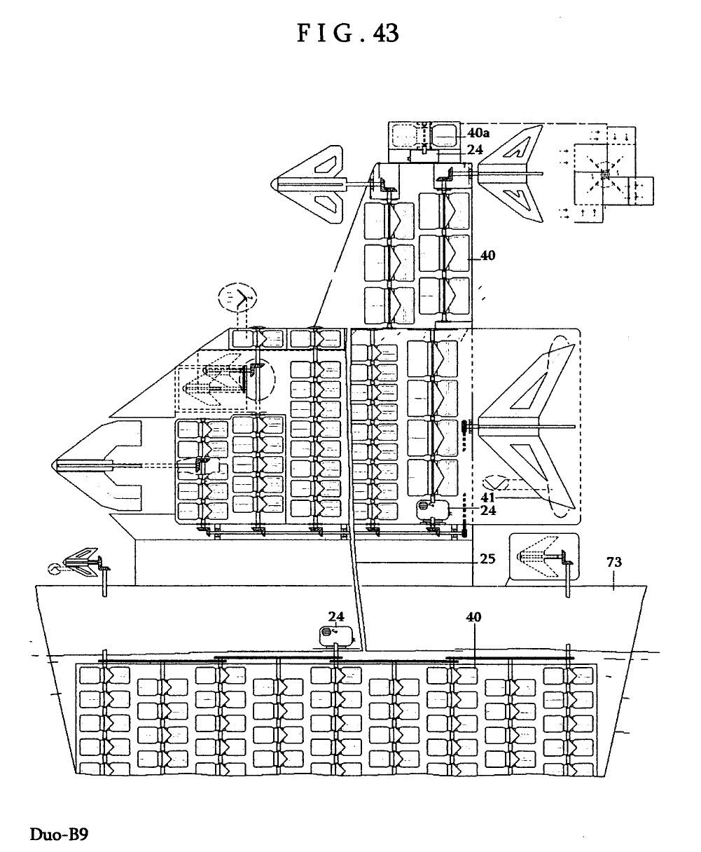

FIG. 43; Duo-B9 Blade energy on ship-9: Half covered blades 40 are equipped blowing by wind power at open sides for rotating alternators/dynamos 24 to generate alternating current, speed acceleration blades 41 for accelerating speed in ship 73, partial cover blade 40a is installed letting wind blowing spin from 4 open sides with alternators 24, motor turns speed blade periodically, ship may be prolonged 25 as desirable.

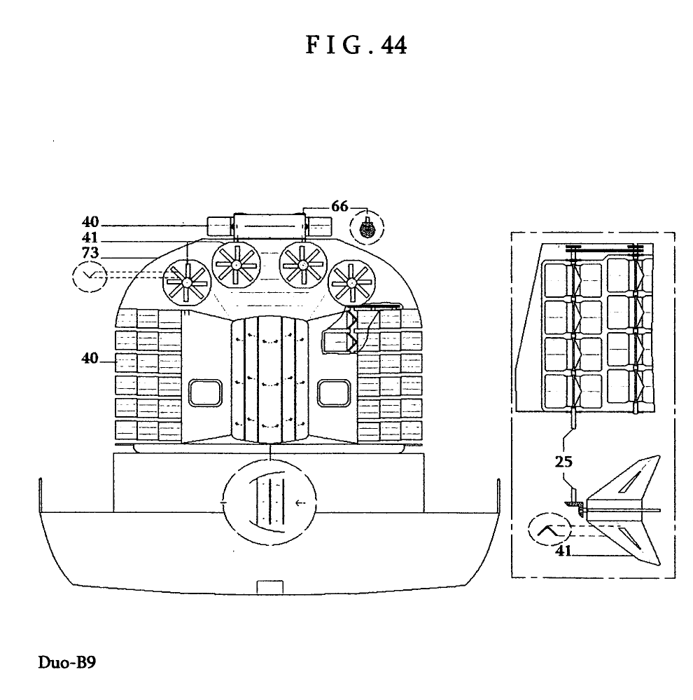

FIG. 44; View of Duo-B9 Blade energy on ship: Half covered blades 40 are equipped in front ship obtaining maximum space of wind blowing power at open sides for rotating alternators to generate alternating current and speed acceleration blades 41 to accelerate speed in ship 73 during ship running under gear 66 connection, wind will blow through openings of its head part center onto opening sides of half covered blades 40 for empowering spin, axis of blades for sailing ship may be prolonged 25 as desirable.

Anti-pollution motors/engines are rotated by moving of compress air, liquid or gas cycle, spring force, pump, energy blades and extra alternators charging battery for motor without using energy as gasoline, fuel, gas and/or nuclear, ignition coil, electric distributor, spark plug, breaker contact, condenser, engine valves, valve springs, fuel pump, fuel filter, fuel tank, complete exhaust & muffler with/without radiator, water pump, thermostat, auxiliary fan.

1. What I claim as my invention is: Using air, compress air in cycle, spring, pump, motor(s) charged battery by multiple/more powerful alternators and energy blades for running all motor/engine vehicles, automobiles, cars, trucks, buses, vans, trains, trolleys, underground trains, tanks, motorcycles, airplanes, ships, submarines, helicopters, space rockets, missiles, fleet, tractors, cultivators, generators, pumps, compressors, machineries, equipments, appliances, motors/engines of all sorts and moving objects of all sorts, including:
air of all sorts in cycle, gas in cycle, liquid of all sorts in cycle, air mixture with/without lubricant in cycle, compress/pressure of air, of gas, of liquid, all under any temperature of all circumstances, their movement; air and/or gas being filled by air compress having air valve, pipes in air cylinder/container with or without spring pressing at end of cylinder, weight under pressure of vehicle, engine, transportation body and/or objects in air cylinder(s)/container(s) for creating maximum force of movement in cycle for pushing pistons, wheels rotating motor/engine in air cycle that air quantity, pressure concluding engine power, half covered blades or equivalents with dynamos be equipped at open sides along moving air/liquid channels to generate electricity,
spring; springs being equipped repulsing force in place of spark plug explosion to pistons for running motor/engine in cycle, comprising springs of all forms, shock absorber, spring pressure, spring pump and/or any other spring force that spring quantity and size concluding engine power, Duo-Ek2 Spring pump piston engine: key to start, motor rotating engine shaft, connecting rod kit, pump with timing belt, pulley, air remaining as intermediate between pumps and pistons in cylinder, equipping two pumps rotated by engine spin, next two spring pumps repulsing for pumping pushing pistons up and down, first pump having a mini-motor with rewind spring, button switch reacted by air meter switch for switching pump opening under air filter pumping air at volume once its pointer dropping below level, alternator(s), battery, oil pump for lubricating equipped, engine axle for connecting to transmission box in vehicle, adjustable bracket of motor speed functioned by driver's accelerator and switched motor off by key contact, motor speed and pumping concluding engine power, engine extendable, modification of engine parts equipping for all uses,
pump; pump rotated by motor, engine cycle pumping air/liquid against pistons, wheels of all forms and/or equivalents for running motor/engine in cycle, quantity and size of pump concluding engine power, “Duo” pump: pump rotated by motor or engine spin having piston with ring, (mini-motor) air filter, spring outlet opening by air suction and closing by air pressure, either a 4-roller or multiple roller wheel being linked with gears and pulley to switch piston unit moving forward and backward for pumping by spring force at the end of its cylinder on engine spin, blowing air pump: two half covered blades being linked gears with pulley, blades rotating wind blowing through between 2 blades into engine without possessing anti-rotating force, spring pump: equipped spring in pump repulsing,
either more alternators being added charging largely battery for generating alternating current to motor or double alter-motor with blade; combination of alternator(s) & motor(s) connected with gear/pulley of axle to (front) wheels for running in cycle, energy blades; half covered blades blown by wind being equipped rotating speed accelerating blades for accelerating speed, one rotating side of blades made as arrow head form therein, Duo-Ef Ei motoring spring engine: key to start by either starter or (motorcycle) kick starter, motor equipped rotating a large gear against a smaller one, shaft, springs for repulsing to keep engine running, installing half covered blades blown by wind at open sides, accelerating speed blades, extra alternators or (motorcycle) flywheel, battery, spare parts, oil pump for lubricating, engine axle for connecting to transmission box in vehicle, motor speed functioned by driver's accelerator, engine switched off by key contact, engine dimension, power as desirable, modification of engine parts equipping for all uses,

2. What I claim as my invention is: Motors, engines run by compress air, gas, liquid in cycle, spring force, air spring pump and extra alternators charging battery to motor for running all motor/engine vehicles, automobiles, cars, trucks, buses, vans, trains, trolleys, underground trains, tanks, motorcycles, airplanes, ships, fleet, submarines, helicopters, space rockets, missiles, tractors, cultivators, generators, pumps, compressors, machineries, equipments, appliances, motors/engines of all sorts and moving objects of all sorts either without using or using least energy as gasoline, fuel, gas and/or nuclear etc, including:
air cylinder/container, pump & air cycle distributor “Duo”: air/liquid distributor as intermediate device between carburetor and engine for distributing air to cylinder timely by engine spin of timing belt & pulley or chain & drive in which piston tube containing 4 or more parts in air distributor cylinder and each part having 2 or more outlets for opening or closing of air rotated by turns,
air carburetor “Duo”: air carburetor for air/liquid cycle engine, its piston having center opening being rotated against carburetor outlet for passing air through it and air ceasing passing whenever piston opening against carburetor body, rewind carburetor bracket of piston with/without rollers in axis linking cable drawn by accelerator, vehicle speed depending air quantity pushing to engine on wide or narrow opening of piston, engine being switched off by cable drawing proper adjustable rewind bracket set by key contact on spin of inner key roller at specific side to close air current,
“Duo”: air cycle substituting gasoline in piston engine: key to start by starter or (motorcycle) kick starter, motor equipped rotating shaft, connecting rod kit, timing belt & pulley/chain & drive to turn either air distributor or engine valves for distributing air timely from air cylinder/container through pipe outlet A, air carburetor into cylinder pushing piston kits down while other two piston kits up pushing air back to air container through pipe outlet B in air cycle keeping engine running, engine axle for connecting to transmission box in vehicle, installing air meter switch, air pump, alternators, battery, oil pump for lubricating, spare parts, engine carburetor functioned by driver's accelerator and switched off on spin of key contact, engine having air releasing bolt, dimension, power as desirable, modification of engine parts equipping for all uses,
Duo-E, Ea, Eb Air cycle & spring piston engine: key to start by starter or (motorcycle) kick starter, motor equipped rotating engine shaft, connecting rod kit, timing belt & pulley/chain & drive for either opening/closing of engine valves or air distributor distributing air cycle timely from air cylinder/container through pipe outlet A, carburetor into cylinder pressing piston kits down while next piston kits up repulsing air back to air container by spring force through pipe outlet B keeping engine running, engine axle for connecting to transmission box in vehicle, installing air meter switch, air pump, alternators or (motorcycle) flywheel, battery, oil pump for lubricating, spare parts, engine carburetor functioned by driver's accelerator and switched off on spin of key contact, engine having air releasing bolt, dimension, power as desirable, modification of engine parts equipping for all uses,
Duo-Ec, Ee Half gear & Draw roller piston spring engines: key to start by starter, motor equipped rotating a large gear against a smaller one for accelerating speed in engine, turning engine shaft, connecting rod kit, timing belt, pulley either axis whose half gear at end part engaging groove part of a piston kit handle or a complete bearing connecting rod kit moving up and down timely under spring repulsed force as main function by motor spin or by motor spin drawing piston kit handle by cable rollers keeping engine running, engine axle for connecting to transmission box in vehicle, oil pump for lubricating, alternators equipped charging battery largely generating for motor which functioned by driver's accelerator and switched off by key contact, engine dimension, power, spare parts as desirable, modification of engine parts equipping for all uses,
Duo-Ed Draw roller piston spring engine: key to start by starter, motor equipped rotating a large gear against a smaller one in engine, turning engine shaft, connecting rod kit, timing belt, pulley with either a half gear of axis engaging groove part of a bar or a bearing fixing axis between its center and rim part circling to press on roller of bar moving up and down timely for drawing piston kit handle by cable rollers under spring force, engine axle for connecting to transmission box in vehicle, oil pump for lubricating, alternators equipped charging battery largely generating for motor which functioned by driver's accelerator and switched off by key contact, engine dimension, power, spare parts as desirable, modification of engine parts equipping for all uses,
Duo-Eg Air cycle vertical & horizontal piston-spring engine: key to start by equipped starter, engine rotating shaft, connecting rod kit, timing belt, pulley, air and/or liquid distributor for distributing air timely from air cylinder/container through pipe, carburetor into cylinder down pushing piston kit, next piston kit up repulsing air back to air cylinder by turns through other pipe to keep engine running, either pistons or springs placing horizontally pushing engine shaft on the half way of circle for accelerating speed, engine axle for connecting to transmission box in vehicle, installing alternators, battery, motor, oil pump for lubricating, spare parts, engine carburetor functioned by driver's accelerator and switched off on spin of key contact, engine having air releasing bolt, dimension, power as desirable, modification of engine parts equipping for all uses,
Duo-Eh to Ehh Air cycle piston multiple angle spring engine: key to start by equipped starter, engine rotating shaft, connecting rod kit, drive & chain, air and/or liquid distributor for distributing air timely from spring air cylinder/container or heavy weight of liquid/solid material piston pressure container through pipe A, carburetor into cylinder down pushing piston kit with rollers, next piston kit up repulsing air back through pipe B to air container by turns and springs/shock absorbers being equipped repulsing engine shaft on every possible angle for accelerating speed in a circle to keep engine running, engine axle for connecting to transmission box in vehicle, installing air meter switch, air pump, alternators, battery, motor, oil pump for lubricating, spare parts, engine carburetor functioned by driver's accelerator and switched off on spin of key contact, engine having air releasing bolt, dimension, power as desirable, modification of engine parts equipping for all uses,
Duo-Ej, Ej1, Ej2, Ek1 Air cycle engine/motor of Tri-semicircle wheel, Cross-form wheel: key to start, motor (flywheel) equipped rotating timing belt & pulley/drive & chain, air and/or liquid distributor for distributing air timely from air cylinder under spring pressure through pipe A, carburetor towards openings A for rotating tri-semicircle wheel or cross-form wheel in engine whose outlet B having air valve with opening by air pressure and closing by spring force, one rotating side of wheel made as arrow head form for smooth spin, even rollers pressed by springs being fixed outer and two sides of wheel(s) for rotating smoothly, engine axle for connecting to transmission box, installing alternators, battery, air meter switch, air pump, spare parts, engine carburetor functioned by driver's accelerator and switched off to close air current on spin of key contact, engine dimension, power as desirable, modification of engine parts equipping for all uses,
Duo-Ek, EK3 Spring pump engine of cross-form wheel: key to start, flywheel/motor equipped rotating spring pump with timing belt & pulley/drive & chain that air passing through air filter, air pump for pumping air to flat part of either four cross-form wheels or any other form wheels on spin, angles of two middle wheel made positioning differently, one rotating side of wheel made as arrow head form for smooth spin, rollers pressing by springs fixed on motor against inner wheel point, either spring pumps or center spring pumps linked to pipes being placed at different angles pumping maximum air possible concluding engine power, engine having outlets with air valves opening by air pressure and closing by spring force, gear/engine axle for connecting to transmission box, installing alternator(s), battery, spare parts, adjustable bracket of flywheel/motor functioned by driver's accelerator and switched off by key contact, engine dimension, power as desirable, modification of engine parts equipping for all uses,
Duo-El, El1 Air spring pump engine of navigation form wheel: key to start, motor equipped rotating engine wheel, pulleys, spring pumps with timing belts that air passing through air filters, half covered blade, air carburetor, pump for pumping air to flat part of either navigation form wheels or any other form wheels on spin, one rotating side of wheel made as arrow head form for smooth spin, either spring pumps or center spring pumps linked with air pipes being placed at different angles pumping maximum air possible concluding engine power, engine having outlets with air valves opening by air pressure and closing by spring force, engine axle for connecting to transmission box in vehicle, installing battery, alternator(s), spare parts, engine carburetor functioned by driver's accelerator and switched motor off on spin of key contact to close air carburetor current, engine dimension, power as desirable, modification of engine parts equipping for all uses,
Blade energy vehicle-Duo-B1, B2, B3: speed acceleration blades being equipped rotating by car engine, half covered blades blown by wind at open parts of blades rotating speed accelerating blades and vehicle wheels running, Blade energy train-Duo-B4, B5, B6, B7, B8 and B9: (gaining maximum space of wind in front train-B5, B6, B7 through openings of its head part center onto opening sides of half covered blades for empowering spin, ship-B9; adding partial cover blade(s) of 4 open sides blown by wind at smooth spin, blade sailing axis at sea extendable) half covered blades being equipped blown by wind power at open parts of blades for rotating alternators and speed acceleration blades for accelerating speed, one rotating side of blades made as arrow head form, motor turning blade periodically, connected electric wires through spring with either conductor or ball bearing to electric wire channel along,
distributor cap of double connection “Duo”: cap of distributor current passing two times or more to each spark plug separately in a circle of engine; spark plug 1: connected position 1 to 5, spark plug 2: 2 to 6, spark plug 3: 3 to 7, spark plug 4: 4 to 8 in a distributor cap electric connection or two head switch of 8 position that an engine of 16 valves-8 pistons replaced by an engine of 8 valves-4 pistons in a 8 position distributor cap, 4 piston by 2 piston engine, 12 piston by 6 piston engine in 12 (1 to 12) position distributor cap (1-7, 2-8, 3-9, 4-10, 5-11, 6-12) for (gasoline/fuel) engine and/or similar connections to same effect,
process of function a Duo-Sa of speedometer switch & air meter switch: speedometer switch indicator being divided into two isolated parts; electrically connected under “0 to 40” or “40 to 80” in which speedometer pointer conducting on indicator (rear) surface either “A” of gasoline/diesel engine or “B” of motor system based on vehicle speed (or air pressure), changing transmission speed forward and backward between “0” point and running point that speedometer switching mini motor engaging therein with semi-circle bracket pressing to move bar being half hidden in gear transmission handle up and down to unlock and lock gear below, bracket spring fixed pushing barrier for positioning bar descending, switches installed for turning motor off at point in (gasoline/fuel) engine, air meter switch; connected using as both air pressure indicator and switch for switching air pump on pumping air to air cylinder once air meter pointer dropping below specific level with color lamp flashing,
process of function b Duo-Sb of speed below a “40”, system “A”; accelerator pedal being pressed for drawing carburetor bracket by cable for engine running, speed above “40”, system “B”; accelerator pedal being pressed deeper for cable drawing rewind bracket of motor running and bar hitting pedal piece under rewind spring up rising rewinding carburetor bracket disconnecting engine and speedometer switch switching gear transmission into “0” point by mini motor, “Duo” accelerator pedals of motor & engine function; speedometer using as a switch for switching air (hydraulic) unit rising accelerator pedal up and down functioning based on “A” of gasoline/diesel engine or “B” of motor system running in Duo-2s,
double or more radiators Duo-Dr of (gasoline/fuel) engine: thermostat based on specific heating temperature being fixed reacting a mini motor rotating its gear for elevating either handle with piston or timing belt with piston in radiator cylinder for closing one radiator of hot water and opening the other one(s) of cool water alternatively in radiator cooling system, switches being installed for turning mini motor off at point, or using air-conditioning system in engine at long distance running,

3. What I claim as my invention is: Using air, compress air in cycle, spring, pump, motor(s) charging battery by multiple/more powerful alternators and energy blades for running all motor/engine vehicles, automobiles, cars, trucks, buses, vans, trains, trolleys, underground trains, tanks, motorcycles, airplanes, ships, submarines, helicopters, space rockets, missiles, fleet, tractors, cultivators, generators, pumps, compressors, machineries, equipments, appliances, motors/engines of all sorts and moving objects of all sorts referring to claim 1 and motors, engines run by compress air, gas, liquid in cycle, spring force, air spring pump and extra alternators charging battery to motor for running all motor/engine vehicles, automobiles, cars, trucks, buses, vans, trains, trolleys, underground trains, tanks, motorcycles, airplanes, ships, fleet, submarines, helicopters, space rockets, missiles, tractors, cultivators, generators, pumps, compressors, machineries, equipments, appliances, motors/engines of all sorts and moving objects of all sorts either without using or using least energy as gasoline, fuel, gas and/or nuclear etc referring to claim 2 wherein the original elements, composition, function, structures, process of making, production, installation, using, of the invention, any other structures, modifications, facilities, replacement of parts being assembled for performing both the same and similar formation referring to fundamentals of the original invention in these documents, combining the invention with all motors/engines run by gasoline, fuel, gas and/or nuclear etc, generators by nuclear energy, engines & motors of all sorts, devices, machineries, equipments, appliances, systems, structures and all objects under other names functioning to the same effect are in the scope of protection of the invention, the invention used everywhere.
